(19) United States
(12) Patent Application Publication
(10) Pub. No.: US 2025/0184061 A1
(43) Pub. Date: Jun. 5, 2025

(54) TIMING ADVANCE FOR TRANSMISSION OF SOUNDING REFERENCE SIGNAL

(71) Applicant: QUALCOMM Incorporated, San Diego, CA (US)

(72) Inventors: Mostafa KHOSHNEVISAN, San Diego, CA (US); Shaozhen GUO, Beijing (CN); Fang YUAN, Beijing (CN); Yan ZHOU, San Diego, CA (US); Tao LUO, San Diego, CA (US)

(21) Appl. No.: 18/841,645

(22) PCT Filed: Apr. 29, 2022
(86) PCT No.: PCT/CN2022/090453

§ 371 Date: Aug. 26, 2024

(51) Int. Cl. H04L 5/00

(52) U.S. Cl. CPC H04L 5/0048

(57) ABSTRACT

Aspects relate to transmission of a sounding reference signal (SRS). In some examples, a user equipment may select a timing advance to be used for transmitting the SRS in a multiple transmit receive point (TRP) scenario. In some examples, the selection of the timing advance may be based on a usage associated with an SRS resource set. In some examples, the selection of the timing advance may be based on a time domain configuration associated with an SRS resource set.

### TECHNICAL FIELD

The technology discussed below relates generally to wireless communication and, more particularly, to the selection of a timing advance value for transmitting a sounding reference signal.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station. A base station may schedule access to a cell to support access by multiple UEs. For example, a base station may allocate different resources (e.g., time domain and frequency domain resources) to be used by different UEs operating within the cell.

A UE may transmit reference signals to a base station. For example, a UE may generate a sounding reference signal (SRS) based on a known sequence and transmit the SRS on resources allocated by the base station. The base station may then estimate the quality of an uplink channel from the UE based on the SRS and/or determine other information based on the SRS. The base station may use this channel estimate or other information to, for example, more efficiently allocate resources and/or specify transmission parameters for communication over one or more channels.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a user equipment may include a transceiver, a memory, and a processor coupled to the transceiver and the memory. The processor and the memory may be configured to receive, via the transceiver, a first configuration identifying a plurality of timing advance values. The processor and the memory may also be configured to receive, via the transceiver, a second configuration for a first sounding reference signal (SRS) resource set. The processor and the memory may be further configured to transmit, via the transceiver, a first SRS on the first SRS resource set using a first timing advance value selected from the plurality of timing advance values based on a usage associated with the first SRS resource set or a time domain configuration associated with the first SRS resource set.

In some examples, a method for wireless communication at a user equipment is disclosed. The method may include receiving a first configuration identifying a plurality of timing advance values. The method may also include receiving a second configuration for a first sounding reference signal (SRS) resource set. The method may further include transmitting a first SRS on the first SRS resource set using a first timing advance value selected from the plurality of timing advance values based on a usage associated with the first SRS resource set or a time domain configuration associated with the first SRS resource set.

In some examples, a user equipment may include means for receiving a first configuration identifying a plurality of timing advance values. The user equipment may also include means for receiving a second configuration for a first sounding reference signal (SRS) resource set. The user equipment may further include means for transmitting a first SRS on the first SRS resource set using a first timing advance value selected from the plurality of timing advance values based on a usage associated with the first SRS resource set or a time domain configuration associated with the first SRS resource set.

In some examples, a non-transitory computer-readable medium has stored therein instructions executable by one or more processors of a user equipment to receive a first configuration identifying a plurality of timing advance values. The computer-readable medium may also have stored therein instructions executable by one or more processors of the user equipment to receive a second configuration for a first sounding reference signal (SRS) resource set. The computer-readable medium may further have stored therein instructions executable by one or more processors of the user equipment to transmit a first SRS on the first SRS resource set using a first timing advance value selected from the plurality of timing advance values based on a usage associated with the first SRS resource set or a time domain configuration associated with the first SRS resource set.

In some examples, a network entity may include a transceiver, a memory, and a processor coupled to the transceiver and the memory. The processor and the memory may be configured to transmit, via the transceiver, a first configuration identifying a plurality of timing advance values. The processor and the memory may also be configured to transmit, via the transceiver, a second configuration for a first sounding reference signal (SRS) resource set. The processor and the memory may further be configured to receive, via the transceiver, a first SRS on the first SRS resource set based on a first timing advance value of the plurality of timing advance values. In some examples, the first timing advance value is associated with a usage associated with the first SRS resource set or a time domain configuration associated with the first SRS resource set.

In some examples, a method for wireless communication at a network entity is disclosed. The method may include transmitting a first configuration identifying a plurality of timing advance values. The method may also include transmitting a second configuration for a first sounding reference signal (SRS) resource set. The method may further include receiving a first SRS on the first SRS resource set based on a first timing advance value of the plurality of timing advance values. In some examples, the first timing advance value is associated with a usage associated with the first SRS resource set or a time domain configuration associated with the first SRS resource set.

In some examples, a network entity may include means for transmitting a first configuration identifying a plurality of timing advance values. The network entity may also include means for transmitting a second configuration for a first sounding reference signal (SRS) resource set. The network entity may further include means for receiving a first SRS on the first SRS resource set based on a first timing advance value of the plurality of timing advance values. In some examples, the first timing advance value is associated with a usage associated with the first SRS resource set or a time domain configuration associated with the first SRS resource set.

In some examples, a non-transitory computer-readable medium has stored therein instructions executable by one or more processors of a network entity to transmit a first configuration identifying a plurality of timing advance values. The computer-readable medium may also have stored therein instructions executable by one or more processors of the network entity to transmit a second configuration for a first sounding reference signal (SRS) resource set. The computer-readable medium may further have stored therein instructions executable by one or more processors of the network entity to receive a first SRS on the first SRS resource set based on a first timing advance value of the plurality of timing advance values. In some examples, the first timing advance value is associated with a usage associated with the first SRS resource set or a time domain configuration associated with the first SRS resource set.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a diagram providing a high-level illustration of one example of a configuration of a disaggregated base station according to some aspects.

FIG. 4 is a schematic illustration of wireless resources in an air interface utilizing orthogonal frequency divisional multiplexing (OFDM) according to some aspects.

FIG. 5 is a schematic illustration of an example of a downlink control region of a slot according to some aspects.

FIGS. 6A, 6B, and 6C are diagrams illustrating exemplary uplink reference signal configurations according to some aspects.

FIG. 7 is a signaling diagram illustrating an example of signaling for scheduling a sounding reference signal (SRS) transmission according to some aspects.

FIG. 8 is a conceptual illustration of uplink and downlink timing according to some aspects.

FIG. 9 is a conceptual illustration of an example of timing advance signaling according to some aspects.

FIG. 10 is a conceptual illustration of an example of a user equipment (UE) communicating with multiple transmit receive points (TRPs) according to some aspects.

FIG. 11 is a conceptual illustration of uplink and downlink timing associated with multiple TRPs according to some aspects.

FIG. 12 is a conceptual illustration of SRS resources according to some aspects.

FIG. 13 is a flow chart illustrating an example timing advance selection method according to some aspects.

FIG. 14 is a flow chart illustrating another example timing advance selection method according to some aspects.

FIG. 15 is a signaling diagram illustrating an example of signaling associated with timing advance selection according to some aspects.

FIG. 16 is a block diagram conceptually illustrating an example of a hardware implementation for a user equipment employing a processing system according to some aspects.

FIG. 17 is a flow chart illustrating an example wireless communication method involving transmitting an SRS according to some aspects.

FIG. 18 is a block diagram conceptually illustrating an example of a hardware implementation for a network entity employing a processing system according to some aspects.

FIG. 19 is a flow chart illustrating an example wireless communication method involving receiving an SRS according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

Various aspects of the disclosure relate to transmission of a sounding reference signal (SRS). A network entity such as a base station may configure the transmission of an SRS by a user equipment (UE).

In some examples, a UE may select a timing advance to be used for transmitting the SRS transmission in a multiple transmit receive point (TRP) scenario. In some examples, the selection of the timing advance may be based on a type of usage associated with an SRS resource set. In some examples, the selection of the timing advance may be based on a type of time domain behavior associated with an SRS resource set.

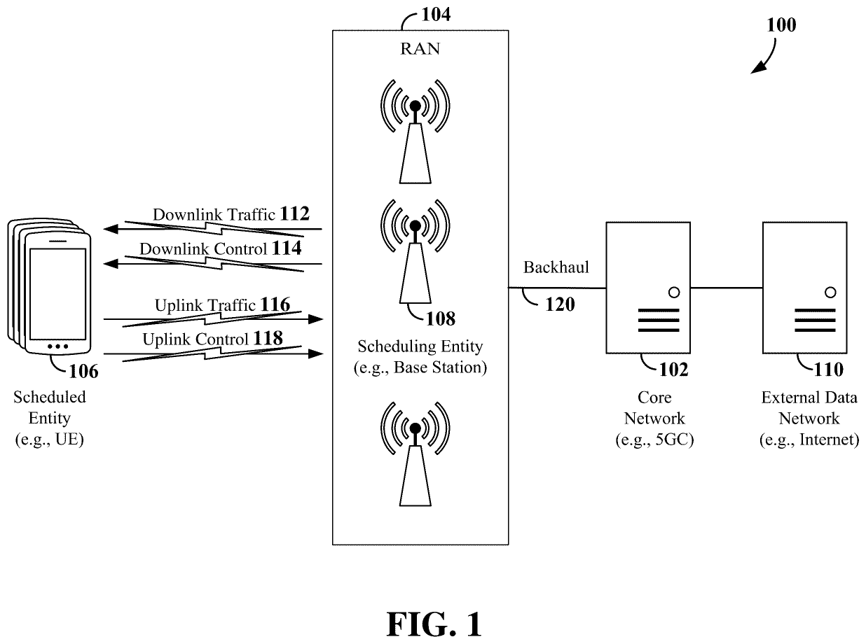

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

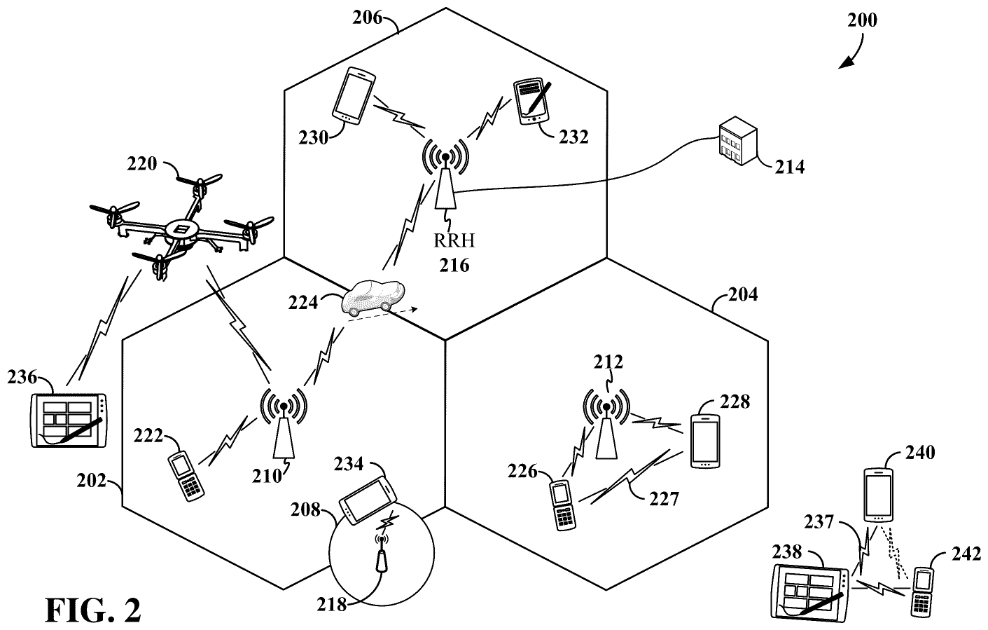

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

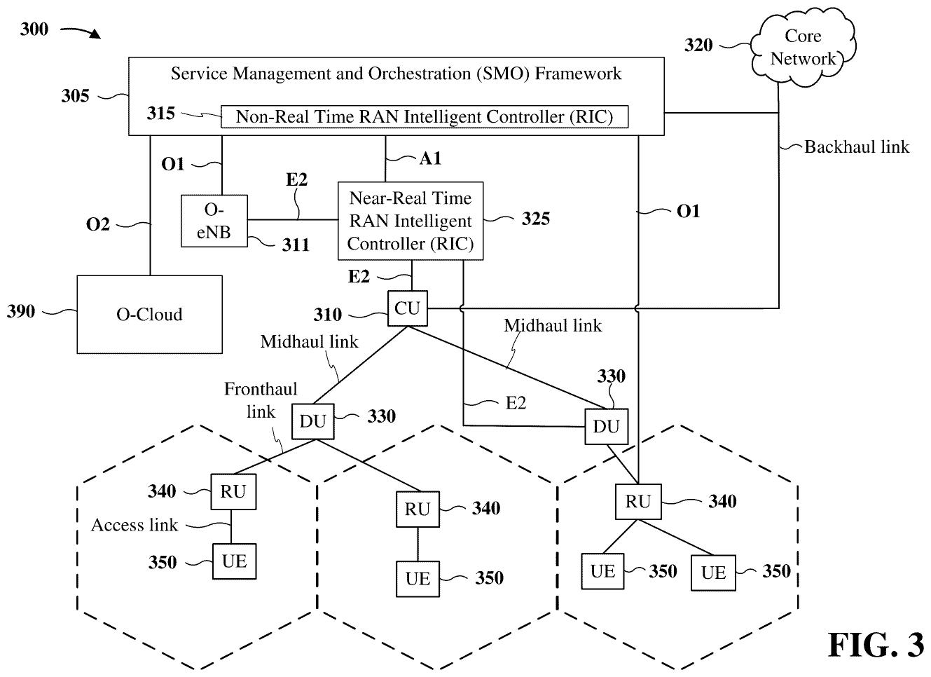

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 350 via one or more radio frequency (RF) access links. In some implementations, the UE 350 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the distributed unit (DU) 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 350. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

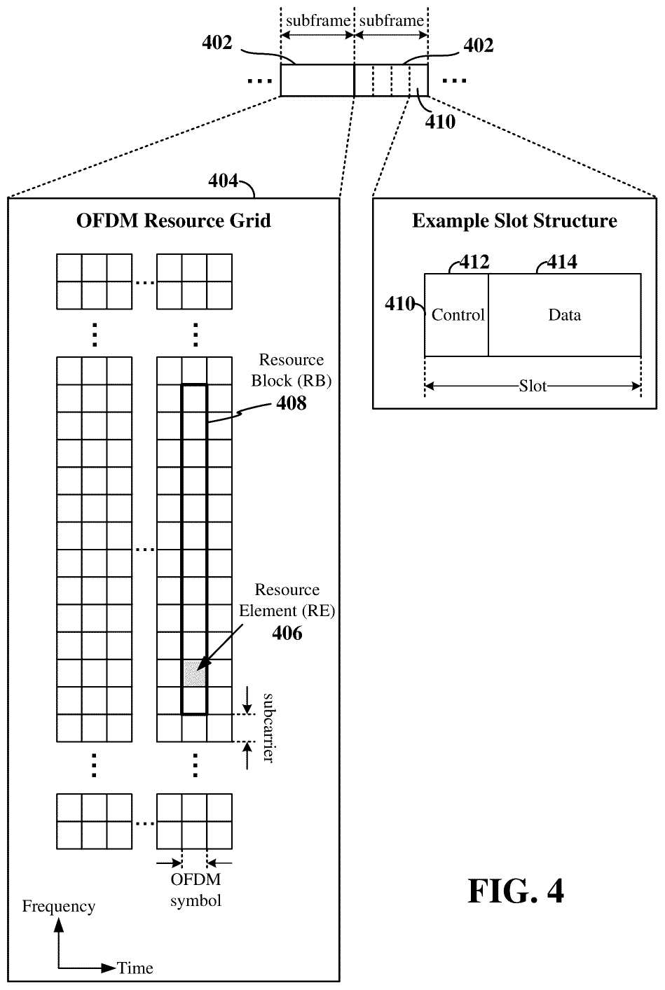

Various aspects of the present disclosure will be described with reference to an OFDM waveform, an example of which is schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an example subframe 402 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely an example, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the UE may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-4 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

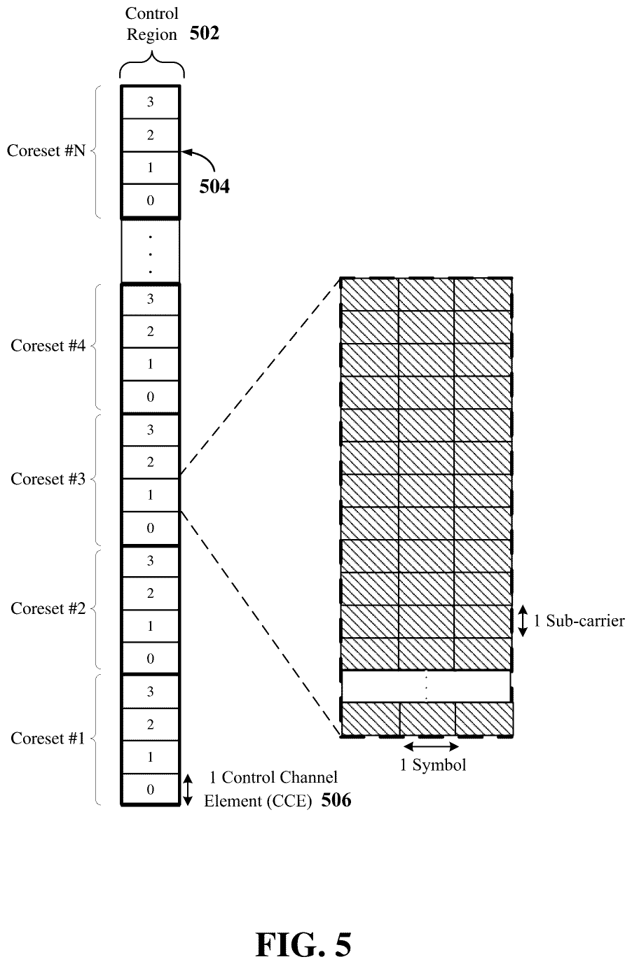

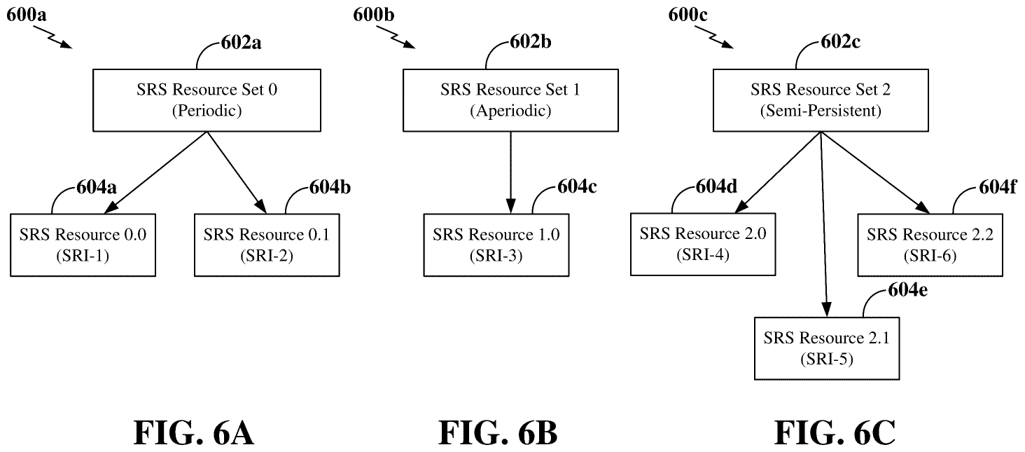

As mentioned above, a base station may use a downlink control region of a slot to send PDCCH information to a UE. In some examples, the PDCCH information may be a scheduling DCI that schedules a downlink transmission to a UE, a scheduling DCI that schedules an uplink transmission by a UE, or a scheduling DCI that schedules some other transmission. In some examples, the PDCCH information may be a non-scheduling DCI (e.g., a DCI that carries information, but does not schedule a transmission). FIGS. 5 and 6 describe example resource configurations that may be used to carry such PDCCH information.

FIG. 5 is a schematic illustration of an example of a downlink (DL) control region 502 of a slot according to some aspects. The DL control region 502 may correspond, for example, to the control region 412 of the slot 410 illustrated in FIG. 4. As discussed above, the DL control region 502 may carry a PDCCH that includes one or more DCIs.

The DL control region 502 includes a plurality of CORESETs 504 indexed as CORESET #1-CORESET #N. Each CORESET 504 includes a number of sub-carriers in the frequency domain and one or more symbols in the time domain. In the example of FIG. 5, each CORESET 504 includes at least one control channel element (CCE) 506 having dimensions in both frequency and time, sized to span across at least three OFDM symbols. A CORESET 504 having a size that spans across two or more OFDM symbols may be beneficial for use over a relatively small system bandwidth (e.g., 5 MHz). However, a one-symbol CORESET may be used in some scenarios.

In some examples, a base station may configure a CORESET 504 for carrying group common control information or UE-specific control information, whereby the CORESET 504 may be used for transmission of a PDCCH including the group common control information or the UE-specific control information to one or more UEs. Each UE may be configured to monitor one or more CORESETs 504 for the UE-specific or group common control information (e.g., on a PDCCH).

In some examples, the PDCCH may be constructed from a variable number of CCEs, depending on the PDCCH format (e.g., aggregation level). Each PDCCH format (e.g., aggregation level) supports a different DCI length. In some examples, PDCCH aggregation levels of 1, 2, 4, 8, and 16 may be supported, corresponding to 1, 2, 4, 8, or 16 contiguous CCEs, respectively.

A bandwidth part (BWP) may be defined within a carrier bandwidth (CBW). According to some aspects, a BWP is a contiguous set of physical resource blocks (PRBs) on a given carrier. The contiguous set of PRBs may correspond to a contiguous set of CCEs. In some examples, a BWP corresponds to a set of 64 PRBs, which represent 648 subcarriers (i.e., 12 REs/REG×6 REGs/CCE×9 CCEs). A base station may configure different sets of these CCEs as common CCEs or UE-specific CCEs.

In some examples, a CORESET may include 48 REGs in one set of eight CCEs. The eight CCEs may be grouped as a first DCI. The following relationships between CORESETs, BWPs, and search spaces are made with reference to some examples of NR; however, the following is an example and non-limiting and other relationships between CORESETs, BWPs, and search spaces (or their equivalents, for example in other radio technologies) are within the scope of the disclosure. In some examples, for a given UE, a base station may configure up to five CORESETs in a BWP of a serving cell (e.g., a component carrier (CC)), including both common and UE-specific CORESETs. In addition, the base station may configure up to four BWPs per serving cell, with one or more of the BWPs active at a given time. The resource elements of a CORESET may be mapped to one or more CCEs.

As mentioned above, a UE may transmit a sounding reference signal (SRS) that a receiving device (e.g., a network entity in some examples) may use for various purposes such as channel estimation, positioning, codebook generation, cross-link interference measurements, and beam selection. For example, for a channel estimation operation, a UE may transmit an SRS to a network entity over a specified bandwidth to enable the network entity to estimate the uplink channel over that bandwidth. In this way, the network entity may better schedule transmissions from the UE (e.g., the network entity may select the frequency band and transmission parameters the UE is to use for an uplink transmission).

The disclosure relates in some aspects to the transmission of a sounding reference signal (SRS). A network entity may transmit, to a UE, SRS configuration information that specifies the SRS resources and other parameters to be used by the UE to transmit an SRS. For example, the network entity may configure one or more SRS resource sets for the UE. In some examples, the UE may use different resource sets for transmitting on different symbols. A defined number of antenna ports may be used for each SRS resource.

In some examples, an antenna port is a logical entity used to map data streams to one or more antennas. Each antenna port may be associated with a reference signal (e.g., which may allow a receiver to distinguish data streams associated with the different antenna ports in a received transmission). For example, logical antenna ports 1000-1999 may be used for SRS transmissions in some networks. An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from MIMO layers may be combined and re-distributed to each of the antenna ports, then precoding is applied, and the precoded data symbols are applied to corresponding REs for OFDM signal generation and transmission via one or more physical antenna elements.

In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

As mentioned above, a network entity may configure multiple SRS resource sets for an SRS transmission by a UE. Each SRS resource set may be configured to be periodic, aperiodic, or semi-persistent, such that each of the SRS resources within the corresponding SRS resource set are periodic, aperiodic, or semi-persistent, respectively. Each SRS resource includes a set of SRS resource parameters configuring the SRS resource. For example, the SRS resource parameters may include a set of antenna port(s) (e.g., uplink beam), number of consecutive symbols, time domain allocation, repetition, transmission comb structure, bandwidth, and other suitable parameters. Each SRS may further be quasi co-located (QCL'ed) with another reference signal, such as an SSB, CSI-RS, or an SRS. The respective sets of SRS resource parameters for each of the SRS resources in a particular SRS resource set collectively form the SRS resource set parameters for the SRS resource set. In addition, the SRS resource set itself may further include additional SRS resource set parameters.

Transmission of an uplink SRS may occur periodically (e.g., as configured via radio resource control (RRC) signaling by a base station), semi-persistently (e.g., as configured via RRC signaling and activated/deactivated via medium access control-control element (MAC-CE) signaling by the base station), or aperiodically (e.g., as triggered by the base station via downlink control information (DCI)). The SRS resource set parameters for an aperiodic SRS resource set may include an aperiodic trigger state (e.g., codepoint) for the aperiodic SRS resource set (e.g., up to three trigger states may be possible in some cases, each mapping to an aperiodic SRS resource set), a slot offset between the slot including a DCI triggering an aperiodic SRS resource and transmission of the SRS (e.g., an SRS is transmitted k slot(s) after the slot carrying the DCI containing the trigger state), and a CSI-RS resource identifier (CRI) associated with an aperiodic SRS resource set for precoder estimation of the aperiodic SRSs. As another example, the SRS configuration for a periodic SRS resource set or a semi-persistent SRS resource set may indicate the periodicity of the SRS resources (e.g., the periodicity of transmission of SRSs).

For a sidelink SRS transmission, a set of sidelink SRS resources, such as a set of symbols in a sidelink slot or a full sidelink slot may be allocated for the transmission of SL-SRSs. The SL-SRS transmission may be independent of any data transmission and may be periodic, semi-persistent, or aperiodic. In examples in which the SL-SRS transmission is periodic, a SL-SRS periodicity between consecutive SL-SRS transmissions of a transmitting device (e.g., a Tx sidelink device) may be defined. For example, the SL-SRS periodicity may be defined via semi-persistent scheduling (SPS) signaling, radio resource control (RRC) signaling, a medium access control (MAC) control element (MAC-CE), or other suitable signaling.

FIGS. 6A, 6B, and 6C are diagrams illustrating exemplary uplink reference signal configurations according to some aspects. The uplink reference signal configurations shown in each of FIGS. 6A-6C may correspond to a single individual reference signal configuration that may be combined with one or more other reference signal configurations to produce a combined reference signal configuration. FIGS. 6A-6C illustrate exemplary SRS configurations 600a-600c for SRS resource sets 602a-602c, each including SRS resources 604a-604f according to some aspects. An SRS resource set may include one or more SRS resources. For example, SRS resource set 602a (SRS Resource Set 0) includes SRS resources 604a and 604b (SRS Resource 0.0 and SRS Resource 0.1), SRS resource set 602b (SRS Resource Set 1) includes SRS resource 604c (SRS Resource 1.0), and SRS resource set 602c (SRS Resource Set 2) includes SRS resource sets 604d, 604e, and 604f (SRS Resource 2.0, SRS Resource 2.1, and SRS Resource 2.2).

As indicated in FIGS. 6A-6C, multiple SRS resource sets 602a-602c may be configured for a UE. In addition, each SRS resource set 602a-602c may be configured to be periodic, aperiodic, or semi-persistent, such that each of the SRS resources within the corresponding SRS resource set are periodic, aperiodic, or semi-persistent, respectively. For example, the SRS resources 604a and 604b within SRS resource set 602a may be periodic SRS resources, the SRS resource 604c within SRS resource set 602b may be aperiodic SRS resources, and the SRS resources 604d-604f within SRS resource set 602c may be semi-persistent SRS resources.

Each SRS resource 604a-604f includes a set of SRS resource parameters configuring the SRS resource. For example, the SRS resource parameters may include a set of port(s), a number of consecutive symbols (Nsymb), time domain allocation (Ioffset), repetition, transmission comb structure (kTC), bandwidth (mSRS), and other suitable parameters. Each SRS may further be quasi co-located (QCL'ed) with another reference signal, such as an SSB, CSI-RS, or another SRS. Thus, based on the quasi co-location (QCL) association (e.g., with an SSB beam, CSI-RS beam, or SRS beam), the SRS resource may be transmitted with the same spatial domain filter (e.g., beam) utilized for reception/transmission of the indicated reference signal (e.g., SSB beam, CSI-RS beam, or SRS beam). Each SRS resource 604a-604f may further be indexed by a respective reference signal resource (ID). The reference signal resource ID may identify not only the particular beam and ports, but also the resources on which the reference signal may be measured. For example, the reference signal resource ID may include an SRS resource indicator (SRI). In the example shown in FIGS. 6A-6C, each SRS resource 604a-604f is indexed by a respective SRI (e.g., SRI-1, SRI-2, SRI-3, SRI-4, SRI-5, and SRI-6). As each SRI identifies a respective beam, each SRI corresponds to a beam identifier (ID).

The respective sets of SRS resource parameters for each of the SRS resources in a particular SRS resource set collectively form the SRS resource set parameters for the SRS resource set. In addition, the SRS resource set itself may further include additional SRS resource set parameters. For example, the SRS resource set parameters for the aperiodic SRS resource set 602b may further include an aperiodic trigger state (e.g., codepoint) for the aperiodic SRS resource set 602b (e.g., up to three trigger states may be possible, each mapping to an aperiodic SRS resource set), a slot offset between the slot including the DCI triggering the aperiodic SRS resource and transmission of the SRS (e.g., SRS is transmitted k slot(s) after the slot carrying the DCI containing the trigger state), and a CRI associated with the aperiodic SRS resource set 602b for precoder estimation of the aperiodic SRSs. As another example, the SRS configuration for a periodic SRS resource set 602a or semi-persistent SRS resource set 602c may indicate the periodicity of the SRS resources (e.g., the periodicity of transmission of SRSs). The respective SRS resource set parameters then collectively form the SRS configuration 600a-600c of the corresponding SRS resource set 602a-602c.

A network entity may semi-statically configure a UE with one or more SRS resource sets 602a-602c via, for example, radio resource control (RRC) signaling. In some examples, the network entity may transmit an RRC message including an RRC configuration (e.g., RRC configuration information element (IE)) indicating the SRS configuration of a particular SRS resource set.

For example, the network entity may semi-statically configure the UE with one or more periodic SRS resource sets 602a that the UE may utilize to generate and transmit periodic SRSs to the network entity. As another example, the network entity may semi-statically configure the UE with one or more aperiodic SRS resource sets 602b and corresponding trigger states. The network entity may then trigger an aperiodic SRS resource set 602b using DCI. As another example, the network entity may semi-statically configure the UE with one or more semi-persistent SRS resource sets 602c. The network entity may then activate or deactivate a semi-persistent SRS resource set 602c using a medium access control (MAC) control element (MAC-CE).

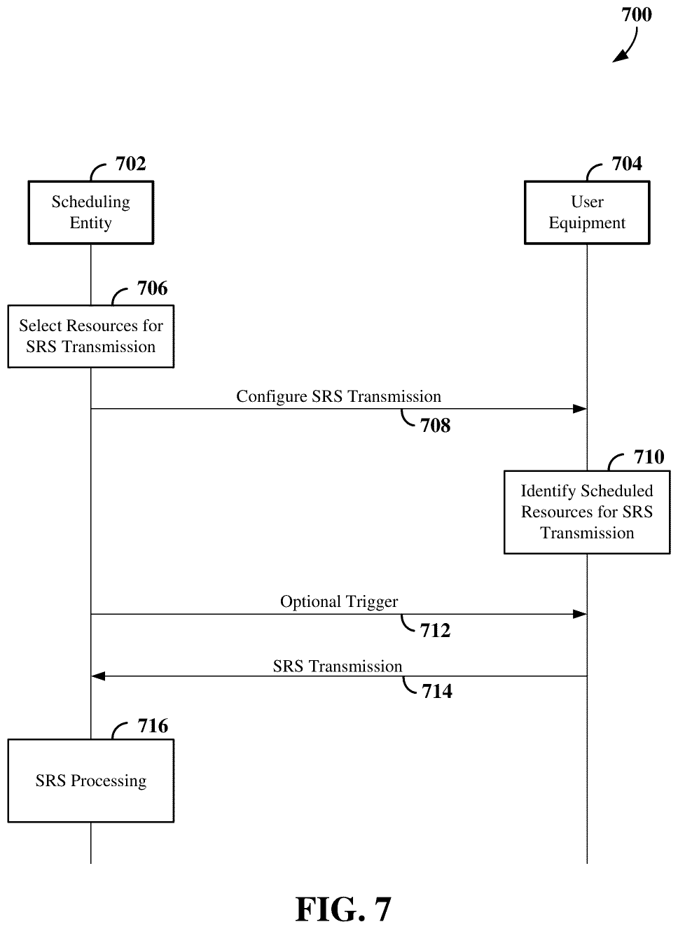

FIG. 7 is a signaling diagram 700 illustrating an example of scheduling an SRS transmission in a wireless communication system including a scheduling entity (e.g., a base station) 702 and a user equipment (UE) 704. In some examples, the scheduling entity 702 may correspond to any of the base stations, CUs, DUs, RUs, or scheduling entities shown in any of FIGS. 1, 2, 3, 8, 9, 15, and 18. In some examples, the user equipment 704 may correspond to any of the UEs or scheduled entities shown in any of FIGS. 1, 2, 3, 8, 9, 15, and 16.

At 706 of FIG. 7, the scheduling entity 702 selects resources for an SRS transmission by the user equipment 704. For example, the scheduling entity 702 may allocate resources for different SRS resource sets under different BWPs under different cells. As another example, the scheduling entity 702 may allocate SL-SRS resources.

At 708, the scheduling entity 702 configures the SRS transmission for the user equipment 704. For example, for an uplink SRS transmission, the scheduling entity 702 (e.g., a base station) may send an RRC message or some other type of message to the user equipment 704, where the message specifies the resources and other information to be used by the user equipment 704 for the SRS transmission.

For a sidelink SRS transmission, the scheduling entity 702 (e.g., a scheduling sidelink UE or a base station) may allocate resources for the transmission of an SL-SRS from the user equipment 704 (e.g., a sidelink UE) to the scheduling entity 702 or to another sidelink UE. In some examples, the resource set may be configured via an RRC message, and a DCI or other signaling may be used activate SRS transmissions (e.g., for aperiodic SRS resources). In some examples, the scheduling entity 702 may transmit an SL-SRS request indicating the allocated periodic, aperiodic, or semi-persistent SL-SRS resources. In some examples, the SL-SRS resources may be configured via an RRC message, and the SL-SRS request may be included within SCI or a MAC-CE to activate the SL-SRS resources (e.g., periodic SL-SRS resources).

At 710, the user equipment 704 identifies the scheduled resources for the SRS transmission. For example, for an uplink SRS transmission, the user equipment 704 may identify the periodic, aperiodic, or semi-persistent SRS resources within a corresponding SRS resource set. For a sidelink SRS transmission, the user equipment 704 may identify the periodic, aperiodic, or semi-persistent SL-SRS resources indicated in the SL-SRS request.

At optional 712, in some examples, a DCI or other signaling may be used to trigger or activate an SRS transmission (e.g., aperiodic SRS) at the user equipment 704.

At 714, the user equipment 704 transmits the SRS transmission on the scheduled resources. For example, for an uplink SRS transmission, the user equipment 704 (e.g., a UE) may transmit an SRS to the scheduling entity 702 (e.g., a base station). For a sidelink SRS transmission, the user equipment 704 (e.g., a scheduled sidelink UE) may transmit an SL-SRS to the scheduling entity 702 (e.g., a sidelink UE) or to another sidelink UE (not shown in FIG. 7). For triggered or activated SRS transmissions, the user equipment 704 transmits the SRS transmission according to the trigger or activation (e.g., indicated by a MAC-CE, a DCI, etc.)

At 716, the scheduling entity 702 processes the SRS transmission received at 714. For example, the scheduling entity 702 may estimate a channel between the scheduling entity 702 and the user equipment 704, estimate a position of the user equipment 704, generate a codebook for communication with the user equipment 704, estimate cross-link interference for communication with the user equipment 704, or select a beam for communication with the user equipment 704.

In some examples, SRS transmissions may be sub-band transmissions where an SRS is transmitted over one or more sub-bands of the allocated SRS bandwidth. For example, a scheduling entity may configure a scheduled entity to use frequency hopping to transmit SRSs over different sub-bands. In some examples, the scheduling entity may configure a hopping scheme for each SRS resource set for a scheduled entity. For frequency hopping, the SRS bandwidth may refer to the total bandwidth that will be hopped across all hops (e.g., during a slot, a set of slots, a set of symbols, or some other time span). For example, a set of SRS bandwidth configurations (C_{SRS}) may be defined that specifies, for different values of C_{SRS}, different SRS hopping bandwidth values for different RB groupings (e.g., 4 RBs per hop, 8 RBs per hop, etc.). Thus, a scheduling entity may send an SRS bandwidth configuration (e.g., a particular C_{SRS} value) to a scheduled entity to configure SRS transmissions by the scheduled entity.

In various examples, an SRS transmission may be a codebook-based transmission or a noncodebook-based transmission. In some examples, for a noncodebook-based SRS transmission, a UE may determine a precoder matrix for the SRS transmission based, at least in part, on a PUSCH precoder. In some examples, for a codebook-based SRS transmission, a UE may determine a precoder matrix for the SRS transmission based, at least in part, on a designated subset of a configured codebook. In some aspects, a codebook may map a set of values (e.g., zeros, ones, etc.) to another set of values (e.g., a set of complex values) for transmission. The UE may select the particular codebook subset to use based on, for example, the number of antenna ports and/or the number of MIMO layers to be used for the SRS transmission.

For uplink transmissions such as SRS transmissions, a 5G NR uplink allows for uplink intracell orthogonality so that the uplink transmissions received from different devices within a cell do not cause interference to each other. A feature for this uplink orthogonality is that the uplink slot boundaries for a given numerology are (approximately) time aligned at the base station. To ensure such receiver-side time alignment, 5G NR includes a mechanism for transmitting a timing advance (TA) signal or indication.

Generally, timing advance is a negative offset applied at a wireless device (e.g., UE), between the start of a downlink (DL) symbol (or subframe) as observed by the device and the start of a symbol in the uplink (UL). By controlling the offset appropriately for each device, the network (e.g., base station or gNB) may control the timing of the signals received at the base station or gNB from the various devices (UEs) in a cell being served. Devices located far from the base station encounter a greater propagation delay, and, therefore, should start their uplink transmissions somewhat in advance, compared to devices located closer to the base station with a less propagation delay.

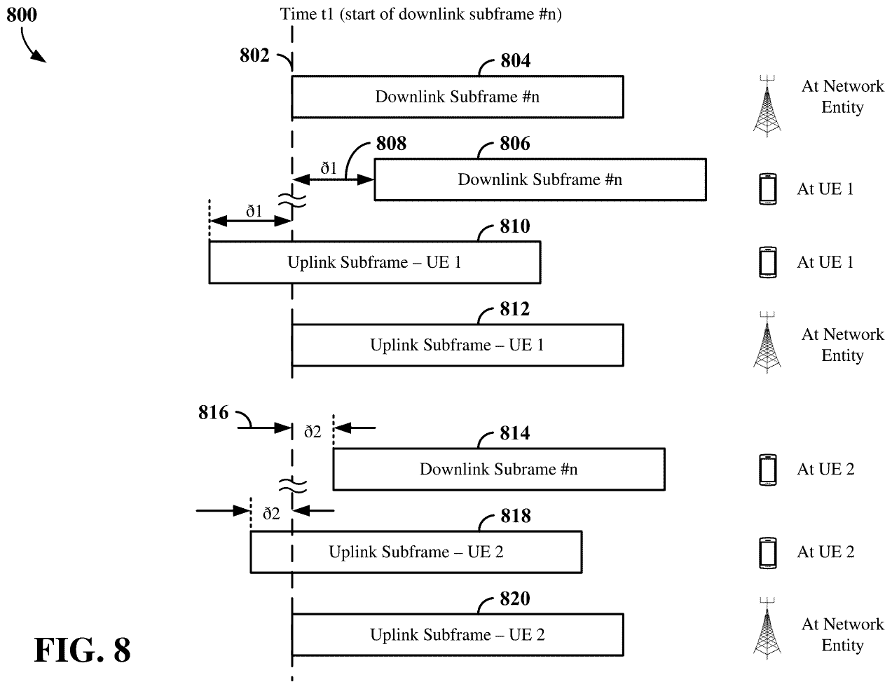

FIG. 8 illustrates an example 800 of downlink and uplink timing. In this example, a first UE (UE 1) is located closer to a network entity (e.g., a gNB) than a second UE (UE 2). Time-aligned downlink transmissions and uplink transmissions are illustrated relative to a time t1 802 that represents a subframe boundary at the network entity.

As represented by a downlink subframe 804 (designated as downlink subframe #n in this example), transmission of a downlink subframe at the network entity starts at the time t1 802. A downlink subframe 806 represents the delayed reception of the downlink subframe 804 at the first UE (UE 1). As indicated, the subframe 806 is received at the first UE (UE1) after a propagation delay δ1 808.

In some aspects, it may be desired that uplink transmissions be received at the network entity time aligned with the network entity's subframe boundary. To this end, based on a timing advance command received from the network entity, the first UE (UE 1) will transmit an uplink subframe 810 at a time that precedes the network entity's subframe boundary by the propagation delay δ1. An uplink subframe 812 represents the delayed reception of the uplink subframe 810 at the network entity. As indicated, this uplink subframe is received time aligned with the network entity's subframe boundary. For convenience, the transmission of the uplink subframe is depicted relative to the time t1 802. It should be appreciated, however, that in a half-duplex system the relative subframe boundary for the uplink transmission would be later in time than the time t1 802.

FIG. 8 further illustrates that the propagation delay δ2 from the network entity to the second UE (UE 2) is smaller than the propagation delay δ1 due to the second UE (UE 2) being closer to the network entity than the first UE (UE 1). A downlink subframe 814 represents the delayed reception of the downlink subframe 804 at the second UE (UE 2). As indicated, the subframe 814 is received at the second UE (UE 2) after a propagation delay δ2 816.

Based on a timing advance command received from the network entity, the second UE (UE 2) will transmit an uplink subframe 818 at a time that precedes the network entity's subframe boundary by the propagation delay δ2. An uplink subframe 820 represents the delayed reception of the uplink subframe 818 at the network entity. As indicated, this uplink subframe is received time aligned with the network entity's subframe boundary. For convenience, the transmission of the uplink subframe is again depicted relative to the time t1 802. It should be appreciated, however, that in a half-duplex system the relative subframe boundary for the uplink transmission would be later in time than the time t1 802.

In some wireless communication systems, each serving cell (e.g., CC) can be associated with one timing advance group (TAG). In some aspects, a TAG may be used to associate multiple cells with the same UL timing advance value. Table 1 illustrates an example of a TAG configuration for a serving cell where the serving cell is assigned a particular TAG identifier (TAG ID). In some examples, a serving cell may be configured with one of four possible TAG identifiers (TAG IDs).

```
TABLE 1
ServingCellConfig ::= SEQUENCE {
  tdd-UL-DL-ConfigurationDedicated TDD-UL-DL-ConfigDedicated
  initialDownlinkBWP BWP-DownlinkDedicated
  ...
  tag-Id ,
}
```

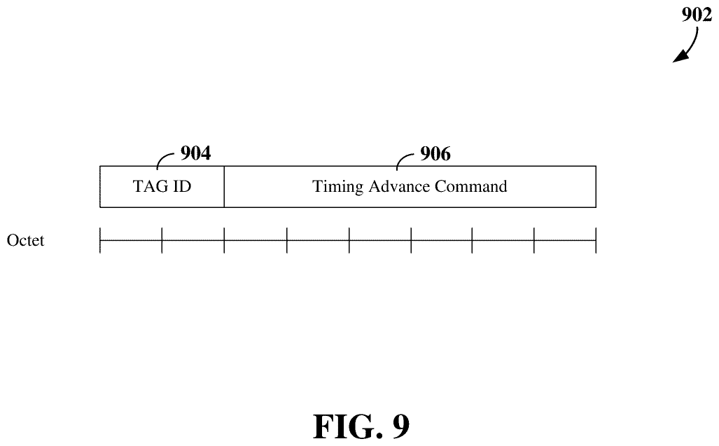

A MAC-CE or some other type of signaling can be used indicate a TA command per TAG. For example, FIG. 9 illustrates a MAC-CE 902 that includes a TAG ID field 904 that carries an identifier of a particular TAG and a timing advance command field 906 that carries the timing advance information associated with that particular TAG.

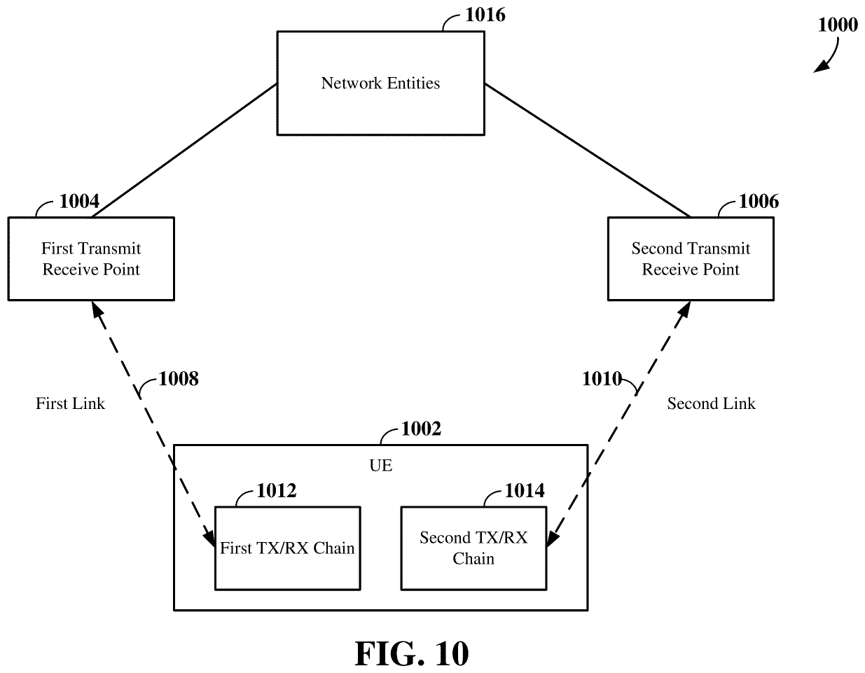

As mentioned above, a UE may communicate with a network via one or more transmit receive points (TRPs). FIG. 10 illustrates a communication system 1000 where a user equipment (UE) 1002 communicates with at least one TRP 1004 and at least one TRP 1006 via a first link 1008 and a second link 1010, respectively. For example, a first transmit receive (TX/RX) chain 1012 of the UE 1002 may communicate with the first TRP 1004 via the first link 1008 (e.g., an uplink and a downlink). In addition, a second TX/RX chain 1014 of the UE 1002 may communicate with the second TRP 1006 via the second link 1010 (e.g., an uplink and a downlink). In different implementations, the TRP 1004 may be a single TRP or a set of TRPs. Similarly, the TRP 1006 may be a single TRP or a set of TRPs. Also, the TRPs 1004 and 1004 may be associated with the same cell or different cells.

In some aspects, a TRP may refer to a physical entity that incorporates RU functionality for a particular physical cell. This functionality may be similar in one or more aspects to (or incorporated into) the RU functionality of a NodeB, an eNodeB, a gNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), or some other similar entity.

As discussed above, the TRPs 1004 and 1006 of FIG. 10 may operate under the control of one or more network entities 1016. For example, the TRPs 1004 and 1006 may be controlled by a single DU. As another example, the TRP 1004 may be controlled by a first DU and the TRP 1006 may be controlled by a second DU. Also, the TRPs 1004 and 1006 may be controlled by a single CU or different CUs.

A UE operating in a multi-TRP scenario (e.g., as shown in FIG. 10) may be scheduled in different ways in different implementations. In some examples, a single DCI is used to schedule an uplink or downlink transmission for the UE via the TRPs. For example, the DCI may schedule a first set of MIMO layers on a first TRP and schedule a second set of MIMO layers on a second TRP.

In other examples, multiple DCIs may be used for a multi-TRP scenario. In such a multi-DCI scenario, a first DCI may be used to schedule an uplink or downlink transmission for the UE via the first TRP, while a second DCI may be used to schedule an uplink or downlink transmission for the UE via the second TRP.

In some wireless communication systems, a multi-TRP scenario may be supported through the use of control resource set pools. Here, the control resource sets (e.g., 5 CORESETs) allocated for a given BWP and component carrier (CC) may be grouped into different groups according to a control resource set pool index (CORESETPoolIndex). For example, a first subset of the control resource sets (e.g., 3 CORESETs) may be assigned to a CORESETPoolIndex 0 and a second subset of the control resource sets (e.g., 2 CORESETs) may be assigned to a CORESETPoolIndex 1. Here, a CORESETPoolIndex is effectively a TRP ID (e.g., CORESETPoolIndex 0 may correspond to TRP 1 and CORESETPoolIndex 1 may correspond to TRP 2).

In some examples, channels/signals (e.g., PUCCH, PUSCH, SRS, etc.) can be associated with a CORESETPoolIndex value. For example, when a UE receives a DCI on a CORESET associated with CORESETPoolIndex 0, the UE can determine that the DCI is from TRP 1. As another example, an RRC configuration may be used to associate a particular channel with a particular CORESETPoolIndex value.

Thus, in some examples, a multi-DCI based multi-TRP scenario may be configured for a BWP/CC by configuring two CORESETPoolIndex values (value 0 and 1) for the CORESETs in the BWP/CC. In addition, in some examples, two TAs in one CC may be associated with the two CORESETPoolIndex values, respectively. Two TAs may be used, for example, because the propagation delay from a UE to different TRPs may be different. Thus, the UE may be configured to use a different TA value for the different TRPs.

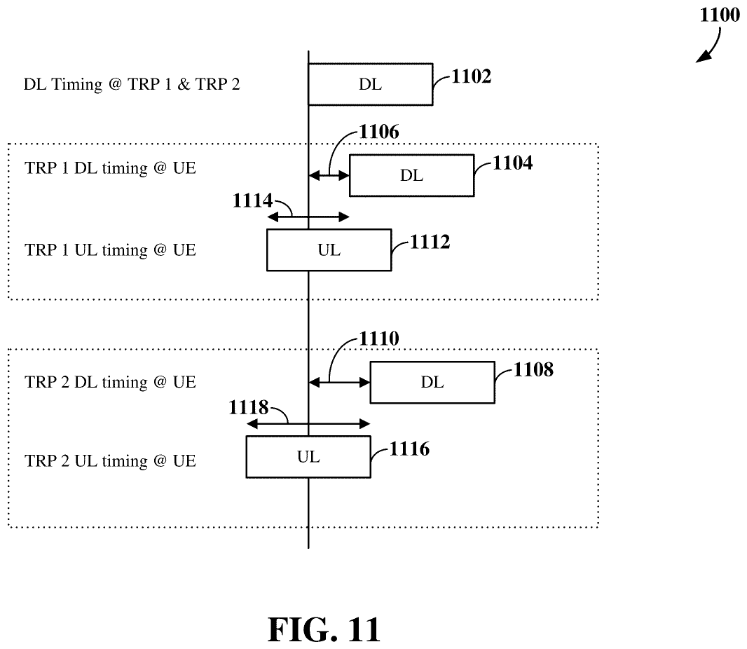

The diagram 1100 of FIG. 11 illustrates an example of uplink (UL) timing and downlink (DL) timing between a UE and two TRPs (TRP 1 and TRP 2). A first message 1102 illustrates the DL timing at TRP 1 and TRP 2. As indicated, the DL timing for TRP 1 and TRP 2 may be synchronized in this example (while it may not be synchronized in other examples).

A second message 1104 illustrates the DL timing associated with TRP 1 at the UE. The propagation delay from TRP 1 to the UE is represented by a line 1106. A third message 1108 illustrates the DL timing associated with TRP 2 at the UE. The propagation delay from TRP 2 to the UE is represented by a line 1110. Here, it may be seen that these propagation delays are different.

With respect to the uplink timing, a fourth message 1112 illustrates the UL timing associated with TRP 1 at the UE. Here, to ensure that the fourth message 1112 (an UL message) is received at TRP 1 at the proper time, the UE may send the fourth message 1112 to TRP 1 a certain amount of time (represented by a line 1114) prior to the second message 1104 (the DL message). A fifth message 1116 illustrates the UL timing associated with TRP 2 at the UE. Here, to ensure that the fifth message 1116 (an UL message) is received at TRP 2 at the proper time, the UE may send the fifth message 1116 to TRP 2 a certain amount of time (represented by a line 1118) prior to the third message 1108 (the DL message). It may thus be seen that the UE may use different timing advance values when transmitting to the different TRPs.

Given the relationship between TRPs and CORESETPoolIndex values discussed above, a UE may use different timing advance values when transmitting channels/signals associated with different CORESETPoolIndex values. Two frameworks are described herein to address this issue.

A first framework (Framework 1) uses two TAGs in a CC. A CC configured with two CORESETPoolIndex values is configured with two TAG IDs, and the two TAs in the CC are associated with the two TAGs. In this case, an association between each UL signal/channel with a TAG ID (among the two TAG IDs) may be defined to determine the TA value for transmission of that signal/channel.

A second framework (Framework 2) uses one TAG in a CC. Here, each CC can be configured with one TAG ID. Nevertheless, a CC configured with two CORESETPoolIndex values can be configured to determine a second TA value relative to the first TA value. For example, the first TA can be associated with the one TAG and the second TA is set equal to the first TA+a delta TA, where the delta TA can be determined based on UE measurements or based on network entity (e.g., gNB) signaling. Again, an association between each UL signal/channel with one of the two TA values may be defined to determine the TA value for transmission of a particular signal/channel.

The disclosure relates in some aspects to techniques for determining the association between a SRS and one of the two configured TA values. This association may be defined in the context of Framework 1 (two TAG-IDs configured for the CC) and/or Framework 2 (one TAG and two TAs).

Prior to discussing these techniques, several aspects of SRS resources and SRS resource sets (e.g., as shown in FIGS. 6A-6C) will be discussed. SRS resources are configured within an SRS resource set consisting of one or more SRS resources. This configuration mechanism simplifies the activation (for semi-persistent SRS) and DCI triggering (for aperiodic SRS) since multiple resources can be activated/triggered simultaneously. A “resourceType” (RRC configuration per SRS resource set) can be configured as aperiodic, semi-persistent, or periodic, which determines the time domain behavior for the SRS.

A “usage” parameter for an SRS resource set can be configured as one of: {beamManagement, codebook, nonCodebook, antennaSwitching}. In some examples, SRS resource sets are configured by an srs-ResourceSetToAddModList parameter. For a codebook (CB) based UL, a UE can be configured with only one SRS resource set with “usage” set to “codebook” in some examples. For a noncodebook (NCB) based UL, a UE can be configured with only one SRS resource set with “usage” set to “noncodebook” in some examples.

In some examples, another (second) list of SRS resource sets can be configured by srs-ResourceSetToAddModListDCI-0-2 associated with DCI format 0_2. For “usage” set to “codebook” or “noncodebook”, only one SRS resource set can be configured in the second list in some examples. The SRS resources of the SRS resource set in the second list are a subset of SRS resources of the SRS resource set in the first list.

In some examples, for either the first list (srs-ResourceSetToAddModList) or the second list (srs-ResourceSetToAddModListDCI-0-2), for “usage” set to “codebook” or “noncodebook”, two SRS resource sets can be configured in the list. The first SRS resource set is the one with the lower SRS resource set ID in the list (associated with a first TRP) and the second SRS resource set is the one with higher SRS resource set ID in the list (associated with a second TRP). The first SRS resource set of the second list is a subset of the first SRS resource set of the first list, and second SRS resource set of the second list is a subset of the second SRS resource set of the first list. In some aspects, the above example applies to the context of single-DCI based multi-TRP PUSCH repetition (e.g., for indicating SRS resources associated with PUSCH repetitions).

In some examples, a similar framework may be used for multi-DCI based PUSCH operation. With either the first list or the second list, the first SRS resource set (with the lower ID) is associated with CORESETPoolIndex value 0 (first TRP) and the second SRS resource set (with the higher ID) is associated with CORESETPoolIndex value 1 (second TRP).

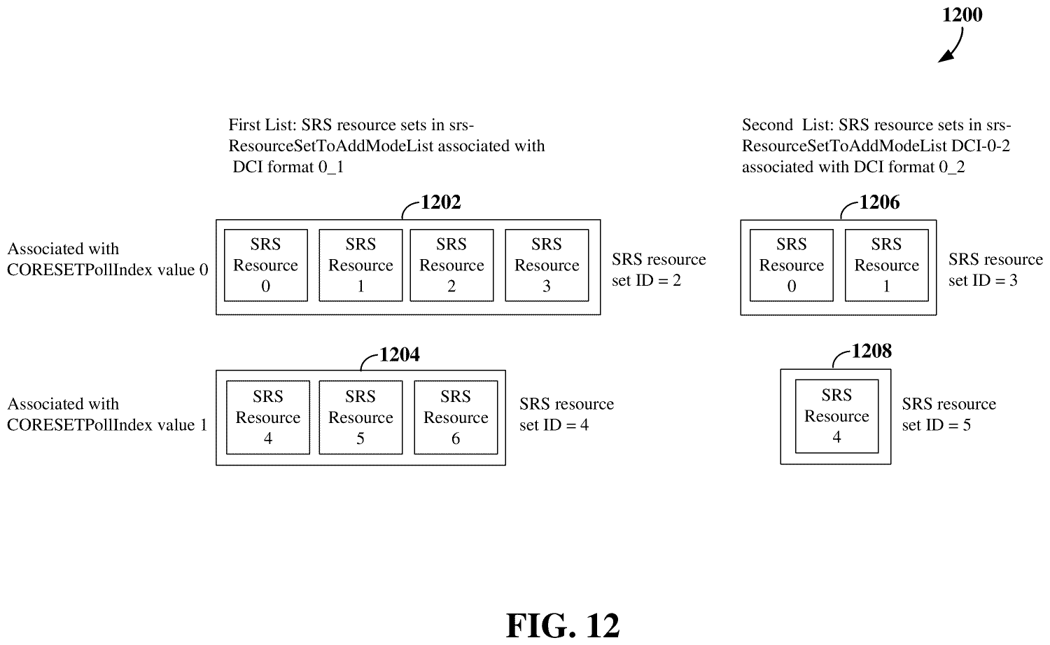

The diagram 1200 of FIG. 12 illustrates an example of the above relationships between SRS resources in different lists. A first list, associated with DCI format 0_1, includes a first SRS resource set 1202 and a second SRS resource set 1204. The first SRS resource set 1202 has an SRS resource ID=2 and the second SRS resource set 1204 has an SRS resource ID=4. Thus, the first SRS resource set 1202 (with the lower SRS resource ID) is associated with CORESETPoolIndex value 0 and second SRS resource set 1204 (with the higher SRS resource ID) is associated with CORESETPoolIndex value 1.

A second list, associated with DCI format 0_2, includes a third SRS resource set 1206 and a fourth SRS resource set 1208. The third SRS resource set 1206 has an SRS resource ID=3 and the fourth SRS resource set 1208 has an SRS resource ID=5. Thus, the third SRS resource set 1206 (with the lower SRS resource ID) is associated with CORESETPoolIndex value 0 and fourth SRS resource set 1208 (with the higher SRS resource ID) is associated with CORESETPoolIndex value 1.

Moreover, as shown in FIG. 12, the SRS resources of the second list are subsets of the SRS resources of the first list. Here, the third SRS resource set 1206 (SRS resources 0 and 1) is a subset of the first SRS resource set 1202 (SRS resources 0, 1, 2, and 3). In addition, the fourth SRS resource set 1208 (SRS resource 4) is a subset of the second SRS resource set 1204 (SRS resources 4, 5, and 6).

The disclosure relates in some aspects to a scenario where a UE is configured with two TA assumptions (TA values) in a CC that is configured with two CORESETPoolIndex values, whereby the UE determines the association of each SRS resource set with one of the two TA assumptions. In some examples, the UE may determine this association based on one or more of the examples described below. Once the UE determines the association (e.g., determines the TA value to be used for an SRS transmission), the UE transmits the SRS resources in the configured SRS resource set using the corresponding TA value.

In a first example (Example 1), the TA is selected based on usage of the SRS resource set and/or based on the SRS resource set ID. For “usage” set to “beamManagement” or “antennaSwitching”, a fixed (e.g., default) one of two TAs may be used. In Framework 1 where two TAGs are used, the fixed TAG may be the first configured TAG-ID for the CC (first in terms of order of RRC configuration) or may be the one with the lower TAG-ID. In Framework 2 where a single TAG is used, the fixed TA may be the one associated with the TAG (and not the one associated with the delta TA).

For “usage” set to “codebook” or “noncodebook”, the association may depend on whether one or two SRS resource sets with that usage are configured in a given list (e.g., either in the first list (srs-ResourceSetToAddModList) or in the second list (srs-ResourceSetToAddModListDCI-0-2)). If there is one SRS resource set in the list, a fixed (e.g., default) one of two TAs may be used, which can depend on Framework 1 versus Framework 2 similar to the other “usage” discussed above. If there are two SRS resource sets in the list, the SRS resource set with the lower ID may be associated with the first TA and the SRS resource set with the higher ID may be associated with the second TA. In Framework 1, the first TA/TAG may be the first configured TAG-ID for the CC (first in terms of order of RRC configuration) or may be the one with the lower TAG-ID, and the second TA/TAG may be the other TA/TAG. In Framework 2, the first TA may be the one associated with the TAG, and the second TA may be the one that is obtained based on applying the delta TA relative to the first TA. This rule may be separately applied for the two lists of SRS resource sets.

In a second example (Example 2), the TA is selected based on the time domain behavior of the SRS resource set (e.g., whether it is periodic/semi-persistent/aperiodic). For periodic or semi-persistent SRS resource sets, a fixed (default) one of two TAs may be used, which can depend on Framework 1 versus Framework 2 similar to the discussions in Example 1. For aperiodic SRS resource sets (triggered by a DCI), the TA may be the one associated with the same CORESETPoolIndex value as the CORESETPoolIndex value of the CORESET in which the DCI is received. In Framework 1, the TA/TAG associated with CORESETPoolIndex value 0 may be the first configured TAG-ID for the CC (first in terms of order of RRC configuration) or may be the one with lower TAG-ID, and the TA/TAG associated with CORESETPoolIndex value 1 may be the other TA/TAG. In Framework 2, the TA associated with CORESETPoolIndex value 0 may be the one associated with the TAG, and the TA associated with CORESETPoolIndex value 1 may be the one that is obtained based on applying the delta TA relative to the first TA.

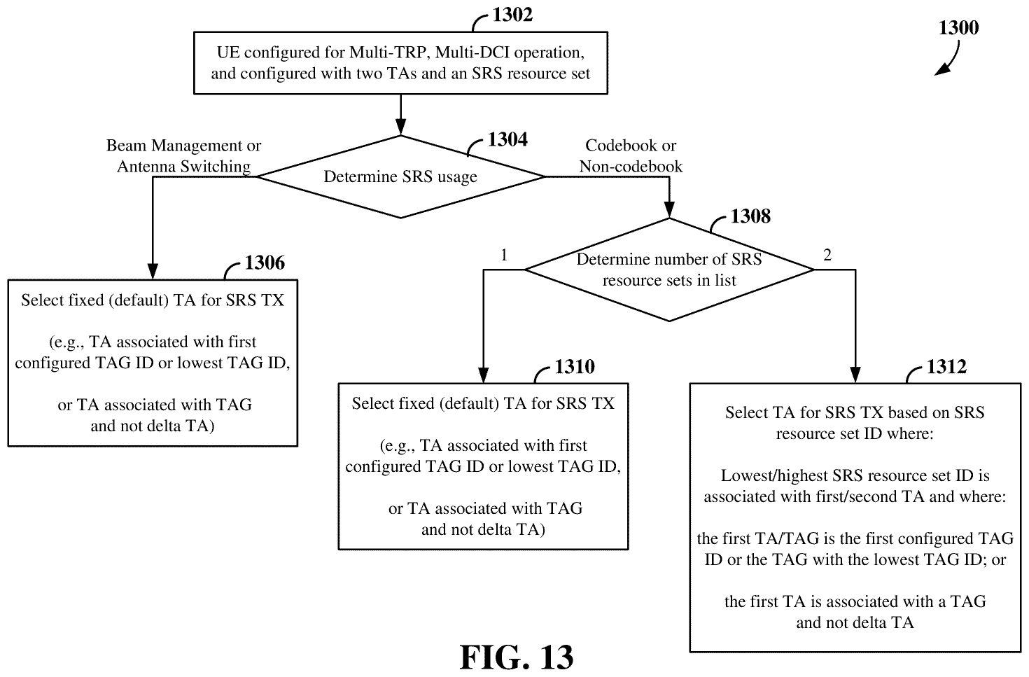

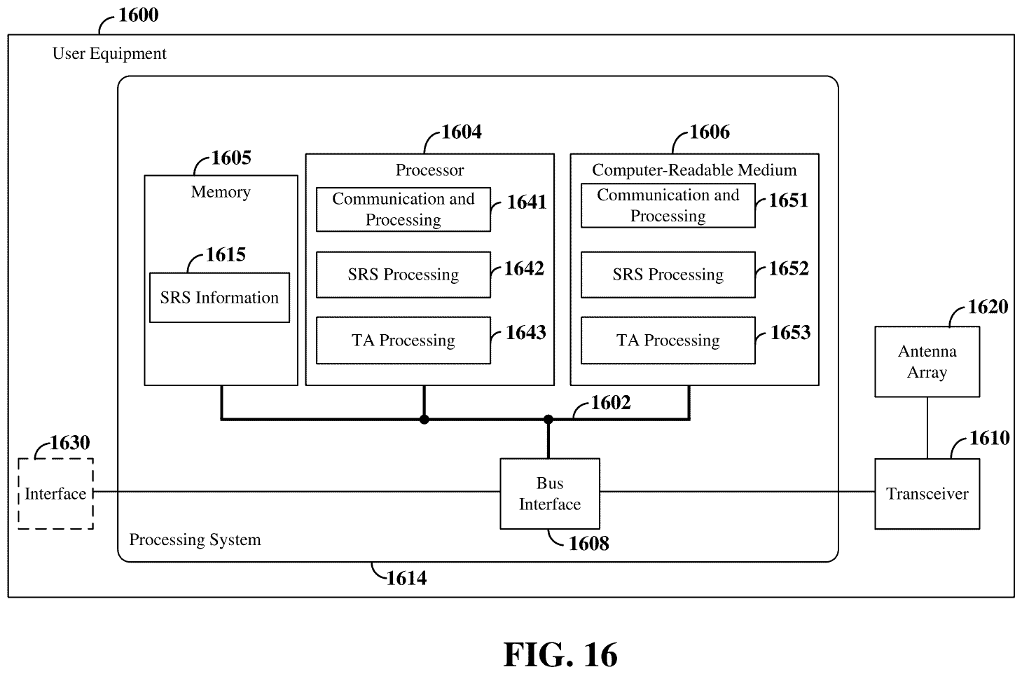

FIG. 13 is a flow chart illustrating a method 1300 applying Example 1 in accordance with some aspects of the present disclosure. As described below, some or all illustrated features may be omitted in a particular implementation within the scope of the present disclosure, and some illustrated features may not be required for implementation of all examples. In some examples, the method 1300 may be carried out by the UE 1600 illustrated in FIG. 16. In some examples, the method 1300 may be carried out by any suitable apparatus or means for carrying out the functions or algorithm described below.

At block 1302 of FIG. 13, a UE is configured for Multi-TRP, Multi-DCI operation on a BWP/CC. In addition, two TAs are configured for the BWP/CC and the UE is configured with a SRS resource set for an SRS transmission.

At block 1304, the UE determines the usage of the SRS resource set. If, at block 1304, the UE determines that the usage is beam management or antenna switching, at block 1306, the UE may select a fixed (default) TA for the SRS transmission. In some examples, the fixed TA is the TA associated with a TAG having the first (earliest) configured TAG ID. In some examples, the fixed TA is the TA associated with a TAG having the lowest TAG ID. In some examples, the fixed TA is the TA associated with a single TAG (i.e., the TA is not a delta TA).

If, at block 1304, the UE determines that the usage is codebook or noncodebook, at block 1308, the UE may determine whether the SRS list includes one or two SRS resource sets.

If, at block 1308, the UE determines that the SRS list includes one SRS resource set, at block 1310, the UE may select a fixed (default) TA for the SRS transmission. In some examples, the fixed TA is the TA associated with a TAG having the first (earliest) configured TAG ID. In some examples, the fixed TA is the TA associated with a TAG having the lowest TAG ID. In some examples, the fixed TA is the TA associated with a single TAG (i.e., the TA is not a delta TA).

If, at block 1308, the UE determines that the SRS list includes two SRS resource sets, at block 1312, the UE may select a TA for the SRS transmission based on the ID of the SRS resource set. In some examples, the lowest SRS resource set ID is associated with the first TA and the highest SRS resource set ID is associated with the second TA. In some examples, the first TA/TAG is the TA/TAG associated with a TAG having the first (earliest) configured TAG ID and the second TA/TAG is the TA/TAG associated with a TAG having the later configured TAG ID. In some examples, the first TA/TAG is the TA/TAG associated with a TAG having the lowest TAG ID and the second TA/TAG is the TA/TAG associated with a TAG having the highest TAG ID. In some examples, the first TA is the TA associated with a single TAG and the second TA is the delta TA.

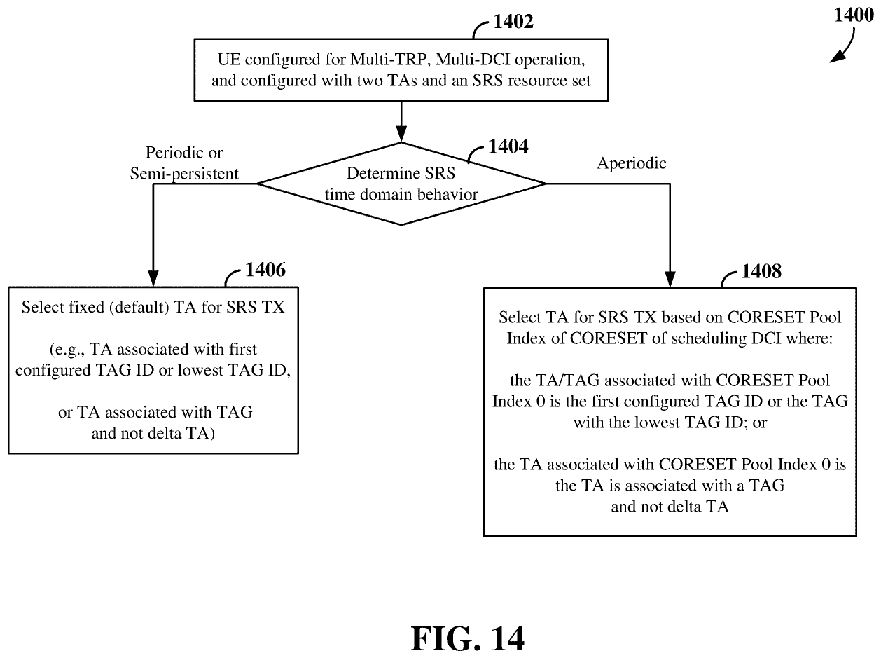

FIG. 14 is a flow chart illustrating a method 1400 applying Example 2 in accordance with some aspects of the present disclosure. As described below, some or all illustrated features may be omitted in a particular implementation within the scope of the present disclosure, and some illustrated features may not be required for implementation of all examples. In some examples, the method 1400 may be carried out by the UE 1600 illustrated in FIG. 16. In some examples, the method 1400 may be carried out by any suitable apparatus or means for carrying out the functions or algorithm described below.

At block 1402 of FIG. 14, a UE is configured for Multi-TRP, Multi-DCI operation on a BWP/CC. In addition, two TAs are configured for the BWP/CC and the UE is configured with a SRS resource set for an SRS transmission.

At block 1404, the UE determines the time domain behavior of the SRS resource set. If, at block 1404, the UE determines that the SRS resource set is configured as periodic or semi-persistent, at block 1406, the UE may select a fixed (default) TA for the SRS transmission. In some examples, the fixed TA is the TA associated with a TAG having the first (earliest) configured TAG ID. In some examples, the fixed TA is the TA associated with a TAG having the lowest TAG ID. In some examples, the fixed TA is the TA associated with a single TAG (i.e., the TA is not a delta TA).

If, at block 1404, the UE determines that the SRS resource set is configured as aperiodic, at block 1408, the UE may select a TA for the SRS transmission based on the CORESETPoolIndex value of the CORESET in which the DCI that triggered the SRS transmission was received. In some examples, the TA/TAG associated with that CORESETPoolIndex value is the TA/TAG associated with a TAG having the first (earliest) configured TAG ID. In some examples, the TA/TAG associated with that CORESETPoolIndex value is the TA/TAG associated with a TAG having the lowest TAG ID. In some examples, the TA associated with that CORESETPoolIndex value is the TA associated with a single TAG (not a delta TA).

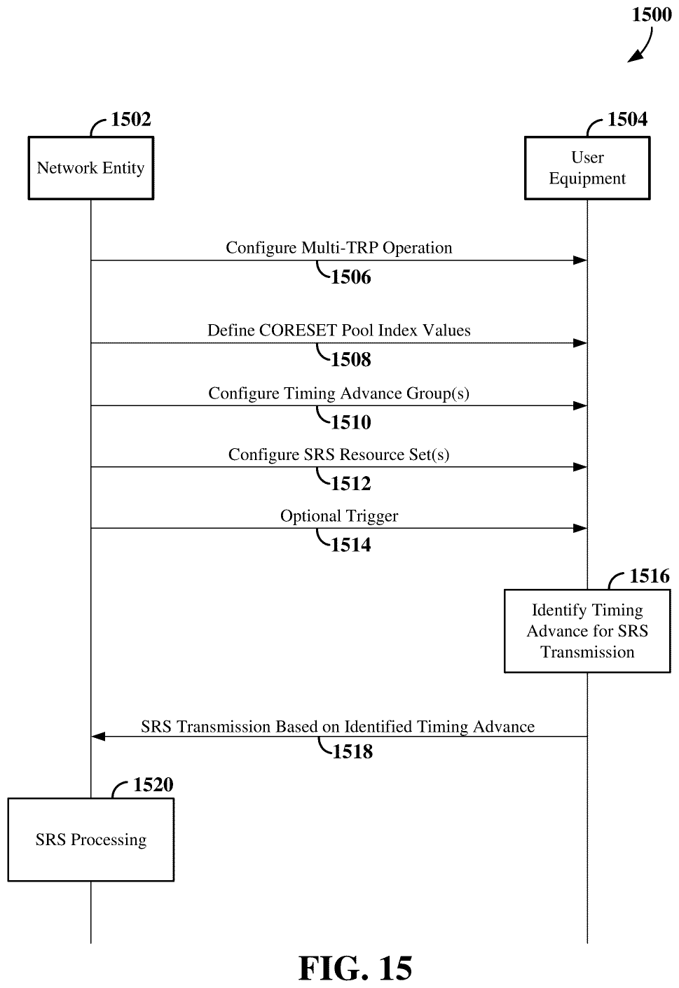

FIG. 15 is a signaling diagram 1500 illustrating an example of identifying a timing advance for an SRS transmission in a wireless communication system including a network entity (e.g., a base station) 1502 and a user equipment (UE) 1504. In some examples, the network entity 1502 may correspond to any of the base stations, CUs, DUs, RUs, or scheduling entities shown in any of FIGS. 1, 2, 3, 7, 8, 9, and 18. In some examples, the user equipment 1504 may correspond to any of the UEs or scheduled entities shown in any of FIGS. 1, 2, 3, 7, 8, 9, and 16.

At 1506 of FIG. 15, the network entity 1502 configures the user equipment 1504 for multi-TRP operation. For example, the network entity 1502 may configure BWPs, search spaces, and other resources for communication between the user equipment 1504 and two TRPs.

At 1508, the network entity 1502 defines CORESET Pool Index values. For example, a first subset of CORESETs allocated for a CC for the user equipment 1504 may be associated with CORESETPoolIndex value 0, and a second subset of the CORESETs allocated for the CC for the user equipment 1504 may be associated with CORESETPoolIndex value 1.

At 1510, the network entity 1502 configures timing advance groups. For example, a first TAG ID and a second TAG ID may be associated with a particular CC configured for the user equipment 1504. As another example, a single TAG ID may be associated with that CC.

At 1512, the network entity 1502 configures resources for SRS transmissions by the user equipment 1504. For example, the network entity 1502 may allocate resources for different SRS resource sets under different BWPs under different cells. As another example, the network entity 1502 may allocate SL-SRS resources. For an uplink SRS transmission, the network entity 1502 (e.g., a base station) may send an RRC message or some other type of message to the user equipment 1504, where the message specifies the resources and other information to be used by the user equipment 1504 for the SRS transmission.

At optional 1514, in some examples, a DCI or other signaling may be used to trigger or activate an SRS transmission (e.g., aperiodic SRS) at the user equipment 1504.

At 1516, the user equipment 1504 identifies the timing advance value to be used to transmit an SRS on the scheduled SRS resources. For example, the user equipment 1504 may identify a timing advance value using one or more of the operations described above in conjunction with FIGS. 13 and 14.

At 1518, the user equipment 1504 transmits the SRS transmission on the scheduled SRS resources using the timing advance value identified at 1516. For example, for an uplink SRS transmission, the user equipment 1504 (e.g., a UE) may transmit an SRS to the network entity 1502 (e.g., a base station). For a sidelink SRS transmission, the user equipment 1504 (e.g., a scheduled sidelink UE) may transmit an SL-SRS to the network entity 1502 (e.g., a sidelink UE) or to another sidelink UE (not shown in FIG. 15). For triggered or activated SRS transmissions, the user equipment 1504 transmits the SRS transmission according to the trigger or activation (e.g., indicated by a MAC-CE, a DCI, etc.)

At 1520, the network entity 1502 processes the SRS transmission received at 1518. For example, the network entity 1502 may estimate a channel between the network entity 1502 and the user equipment 1504, estimate a position of the user equipment 1504, generate a codebook for communication with the user equipment 1504, estimate cross-link interference for communication with the user equipment 1504, or select a beam for communication with the user equipment 1504.

FIG. 16 is a block diagram illustrating an example of a hardware implementation for a UE 1600 employing a processing system 1614. For example, the UE 1600 may be a device configured to wirelessly communicate with a network entity, as discussed in any one or more of FIGS. 1-15. In some implementations, the UE 1600 may correspond to any of the UEs or scheduled entities shown in any of FIGS. 1, 2, 3, 7, 8, 9, and 15.

In accordance with various aspects of the disclosure, an element, or any portion of an element, or any combination of elements may be implemented with the processing system 1614. The processing system 1614 may include one or more processors 1604. Examples of processors 1604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1600 may be configured to perform any one or more of the functions described herein. That is, the processor 1604, as utilized in a UE 1600, may be used to implement any one or more of the processes and procedures described herein.

The processor 1604 may in some instances be implemented via a baseband or modem chip and in other implementations, the processor 1604 may include a number of devices distinct and different from a baseband or modem chip (e.g., in such scenarios as may work in concert to achieve the examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1614 may be implemented with a bus architecture, represented generally by the bus 1602. The bus 1602 may include any number of interconnecting buses and bridges depending on the specific application of the processing system 1614 and the overall design constraints. The bus 1602 communicatively couples together various circuits including one or more processors (represented generally by the processor 1604), a memory 1605, and computer-readable media (represented generally by the computer-readable medium 1606). The bus 1602 may also link various other circuits such as timing sources, peripherals, voltage regulators, and power management circuits, which are well known in the art, and therefore, will not be described any further. A bus interface 1608 provides an interface between the bus 1602, a transceiver 1610 and an antenna array 1620 and between the bus 1602 and an interface 1630. The transceiver 1610 provides a communication interface or means for communicating with various other apparatus over a wireless transmission medium. The interface 1630 provides a communication interface or means of communicating with various other apparatuses and devices (e.g., other devices housed within the same apparatus as the UE 1600 or other external apparatuses) over an internal bus or external transmission medium, such as an Ethernet cable. Depending upon the nature of the apparatus, the interface 1630 may include a user interface (e.g., keypad, display, speaker, microphone, joystick). Of course, such a user interface is optional, and may be omitted in some examples, such as an IoT device.

The processor 1604 is responsible for managing the bus 1602 and general processing, including the execution of software stored on the computer-readable medium 1606. The software, when executed by the processor 1604, causes the processing system 1614 to perform the various functions described below for any particular apparatus. The computer-readable medium 1606 and the memory 1605 may also be used for storing data that is manipulated by the processor 1604 when executing software. For example, the memory 1605 may store SRS information 1615 (e.g., SRS resource information) used by the processor 1604 for the communication operations described herein.

One or more processors 1604 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1606.

The computer-readable medium 1606 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1606 may reside in the processing system 1614, external to the processing system 1614, or distributed across multiple entities including the processing system 1614. The computer-readable medium 1606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

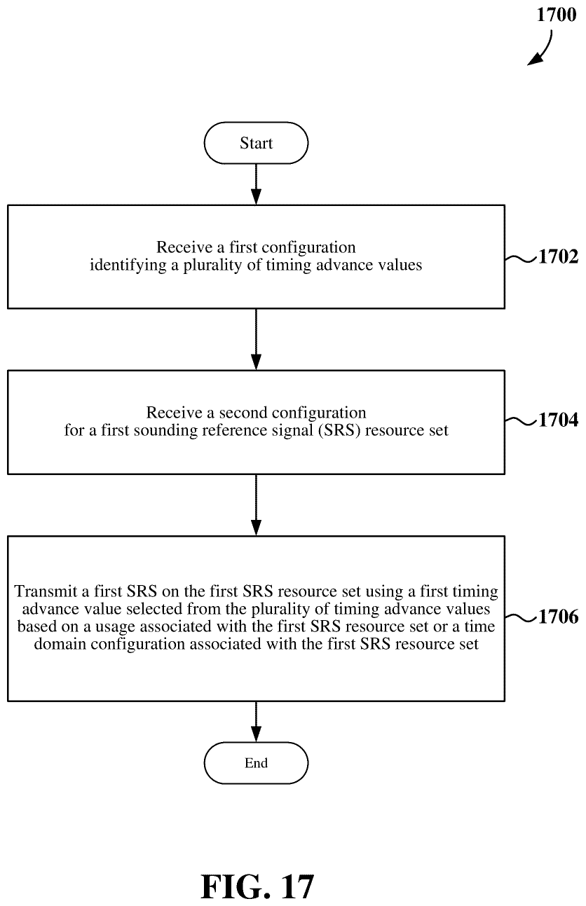

The UE 1600 may be configured to perform any one or more of the operations described herein (e.g., as described above in conjunction with FIGS. 1-15 and as described below in conjunction with FIG. 17). In some aspects of the disclosure, the processor 1604, as utilized in the UE 1600, may include circuitry configured for various functions.

The processor 1604 may include communication and processing circuitry 1641. The communication and processing circuitry 1641 may be configured to communicate with a network entity, such as a gNB. The communication and processing circuitry 1641 may be configured to communicate with a base station and one or more other wireless communication devices over a common carrier shared between a cellular (e.g., Uu) interface and a sidelink (e.g., PC5) interface. The communication and processing circuitry 1641 may include one or more hardware components that provide the physical structure that performs various processes related to wireless communication (e.g., signal reception and/or signal transmission) as described herein. The communication and processing circuitry 1641 may further include one or more hardware components that provide the physical structure that performs various processes related to signal processing (e.g., processing a received signal and/or processing a signal for transmission) as described herein. In some examples, the communication and processing circuitry 1641 may include two or more transmit/receive chains (e.g., one chain to communicate with a base station and another chain to communicate with a sidelink device). The communication and processing circuitry 1641 may further be configured to execute communication and processing software 1651 included on the computer-readable medium 1606 to implement one or more functions described herein.

In some implementations where the communication involves receiving information, the communication and processing circuitry 1641 may obtain information from a component of the UE 1600 (e.g., from the transceiver 1610 that receives the information via radio frequency signaling or some other type of signaling suitable for the applicable communication medium), process (e.g., decode) the information, and output the processed information. For example, the communication and processing circuitry 1641 may output the information to another component of the processor 1604, to the memory 1605, or to the bus interface 1608. In some examples, the communication and processing circuitry 1641 may receive one or more of signals, messages, other information, or any combination thereof. In some examples, the communication and processing circuitry 1641 may receive information via one or more channels. In some examples, the communication and processing circuitry 1641 may receive one or more of signals, messages, SCIs, feedback, other information, or any combination thereof. In some examples, the communication and processing circuitry 1641 may receive information via one or more of a PSCCH, a PSSCH, a PSFCH, some other type of channel, or any combination thereof. In some examples, the communication and processing circuitry 1641 may include functionality for a means for receiving. In some examples, the communication and processing circuitry 1641 may include functionality for a means for decoding.

In some implementations where the communication involves sending (e.g., transmitting) information, the communication and processing circuitry 1641 may obtain information (e.g., from another component of the processor 1604, the memory 1605, or the bus interface 1608), process (e.g., encode) the information, and output the processed information. For example, the communication and processing circuitry 1641 may output the information to the transceiver 1610 (e.g., that transmits the information via radio frequency signaling or some other type of signaling suitable for the applicable communication medium). In some examples, the communication and processing circuitry 1641 may send one or more of signals, messages, other information, or any combination thereof. In some examples, the communication and processing circuitry 1641 may send information via one or more channels. In some examples, the communication and processing circuitry 1641 may send one or more of signals, messages, SCIs, feedback, other information, or any combination thereof. In some examples, the communication and processing circuitry 1641 may send information via one or more of a PSCCH, a PSSCH, a PSFCH, some other type of channel, or any combination thereof. In some examples, the communication and processing circuitry 1641 may include functionality for a means for sending (e.g., a means for transmitting). In some examples, the communication and processing circuitry 1641 may include functionality for a means for encoding. In some examples, the communication and processing circuitry 1641 may include functionality for a means for transmitting an SRS on an SRS resource using a selected TA value.

The processor 1604 may include SRS processing circuitry 1642 configured to perform SRS processing-related operations as discussed herein (e.g., one or more of the operations described above in conjunction with FIGS. 13-15). The SRS processing circuitry 1642 may be configured to execute SRS processing software 1652 included on the computer-readable medium 1606 to implement one or more functions described herein.

The SRS processing circuitry 1642 may include functionality for a means for receiving a configuration for an SRS resource set (e.g., as described above in conjunction with FIGS. 13-15). For example, the SRS processing circuitry 1642 may receive an RRC message including the configuration from a network entity via a PDSCH.

The processor 1604 may include TA processing circuitry 1643 configured to perform TA processing-related operations as discussed herein (e.g., one or more of the operations described above in conjunction with FIGS. 13-15). The TA processing circuitry 1643 may be configured to execute TA processing software 1653 included on the computer-readable medium 1606 to implement one or more functions described herein.

The TA processing circuitry 1643 may include functionality for a means for receiving a configuration identifying TA values (e.g., as described above in conjunction with FIGS. 13-15). For example, the TA processing circuitry 1643 may receive an RRC message including the configuration from a network entity via a PDSCH.

FIG. 17 is a flow chart illustrating an example method 1700 for a user equipment in accordance with some aspects of the present disclosure. As described below, some or all illustrated features may be omitted in a particular implementation within the scope of the present disclosure, and some illustrated features may not be required for implementation of all examples. In some examples, the method 1700 may be carried out by the UE 1600 illustrated in FIG. 16. In some examples, the method 1700 may be carried out by any suitable apparatus or means for carrying out the functions or algorithm described below.

At block 1702, a user equipment may receive a first configuration identifying a plurality of timing advance values. In some examples, the TA processing circuitry 1643 together with the communication and processing circuitry 1641 and the transceiver 1610, shown and described in FIG. 16, may provide a means to receive a first configuration identifying a plurality of timing advance values.

At block 1704, the user equipment may receive a second configuration for a first sounding reference signal (SRS) resource set. In some examples, the SRS processing circuitry 1642 together with the communication and processing circuitry 1641 and the transceiver 1610, shown and described in FIG. 16, may provide a means to receive a second configuration for a first sounding reference signal (SRS) resource set.

At block 1706, the user equipment may transmit a first SRS on the first SRS resource set using a first timing advance value selected from the plurality of timing advance values based on a usage associated with the first SRS resource set or a time domain configuration associated with the first SRS resource set. In some examples, the SRS processing circuitry 1642 together with the communication and processing circuitry 1641 and the transceiver 1610, shown and described in FIG. 16, may provide a means to transmit a first SRS on the first SRS resource set using a first timing advance value selected from the plurality of timing advance values based on a usage associated with the first SRS resource set or a time domain configuration associated with the first SRS resource set.

In some examples, the user equipment may receive a third configuration including a first control resource set pool value and a second control resource set pool value, the first control resource set pool value being associated with the first timing advance value, and the second control resource set pool value being associated with a second timing advance value of the plurality of timing advance values. In some examples, the first control resource set pool value is associated with a first transmit receive point. In some examples, the second control resource set pool value is associated with a second transmit receive point.

In some examples, the first timing advance value may include a default timing advance value (e.g., associated with beam management SRS usage or antenna switching SRS usage). In some examples, the first timing advance value is associated with a first timing advance group (TAG). In some examples, a second timing advance value of the plurality of timing advance values is associated with a second TAG configured after the first TAG. In some examples, the first timing advance value is associated with a first timing advance group (TAG) associated with a first TAG identifier. In some examples, a second timing advance value of the plurality of timing advance values is associated with a second TAG associated with a second TAG identifier. In some examples, the first TAG identifier has a lower identifier value than the second TAG identifier. In some examples, the first timing advance value is associated with a first timing advance group (TAG). In some examples, a second timing advance value of the plurality of timing advance values is defined based on an offset time value relative to the first timing advance value.

In some examples, the first SRS resource set is associated with codebook SRS usage or noncodebook SRS usage. In some examples, the first SRS resource set is included in an SRS resource set list that is restricted to a single SRS resource set for codebook SRS usage or noncodebook SRS usage. In some examples, the first timing advance value may include a default timing advance value (e.g., associated with the SRS resource set list). In some examples, the first timing advance value is associated with a first timing advance group (TAG). In some examples, a second timing advance value of the plurality of timing advance values is associated with a second TAG configured after the first TAG. In some examples, the first timing advance value is associated with a first timing advance group (TAG) associated with a first TAG identifier. In some examples, a second timing advance value of the plurality of timing advance values is associated with a second TAG associated with a second TAG identifier. In some examples, the first TAG identifier has a lower identifier value than the second TAG identifier. In some examples, the first timing advance value is associated with a first timing advance group (TAG). In some examples, a second timing advance value of the plurality of timing advance values is defined based on an offset time value relative to the first timing advance value.

In some examples, the first SRS resource set is associated with codebook SRS usage or noncodebook SRS usage. In some examples, the user equipment may select the first timing advance value based on a first identifier associated with the first SRS resource set. In some examples, the first SRS resource set is included in an SRS resource set list that includes a second SRS resource set. In some examples, the first SRS resource set is associated with the first timing advance value. In some examples, the second SRS resource set is associated with a second identifier and a second timing advance value of the plurality of timing advance values. In some examples, the first identifier has a lower identifier value than the second identifier. In some examples, the first timing advance value is associated with a first timing advance group (TAG). In some examples, the second timing advance value is associated with a second TAG configured after the first TAG. In some examples, the first timing advance value is associated with a first timing advance group (TAG) associated with a first TAG identifier. In some examples, the second timing advance value is associated with a second TAG associated with a second TAG identifier. In some examples, the first TAG identifier has a lower identifier value than the second TAG identifier. In some examples, the first timing advance value is associated with a first timing advance group (TAG). In some examples, a second timing advance value of the plurality of timing advance values is defined based on an offset time value relative to the first timing advance value.

In some examples, the first timing advance value may include a default timing advance value (e.g., associated with periodic SRS resource sets or semi-persistent SRS resource sets). In some examples, the first timing advance value is associated with a first timing advance group (TAG). In some examples, a second timing advance value of the plurality of timing advance values is associated with a second TAG configured after the first TAG. In some examples, the first timing advance value is associated with a first timing advance group (TAG) associated with a first TAG identifier. In some examples, a second timing advance value of the plurality of timing advance values is associated with a second TAG associated with a second TAG identifier. In some examples, the first TAG identifier has a lower identifier value than the second TAG identifier. In some examples, the first timing advance value is associated with a first timing advance group (TAG). In some examples, a second timing advance value of the plurality of timing advance values is defined based on an offset time value relative to the first timing advance value.

In some examples, the user equipment may receive, on a first control resource set, first downlink control information (DCI) that schedules the first SRS resource set as an aperiodic SRS resource set. In some examples, the first control resource set is associated with a first control resource set pool value of a plurality of control resource set pool values. In some examples, the first timing advance value is associated with the first control resource set pool value. In some examples, the first timing advance value is associated with a first timing advance group (TAG). In some examples, a second timing advance value of the plurality of timing advance values is associated with a second TAG configured after the first TAG. In some examples, the first timing advance value is associated with a first timing advance group (TAG) associated with a first TAG identifier. In some examples, a second timing advance value of the plurality of timing advance values is associated with a second TAG associated with a second TAG identifier. In some examples, the first TAG identifier has a lower identifier value than the second TAG identifier. In some examples, the first timing advance value is associated with a first timing advance group (TAG). In some examples, a second timing advance value of the plurality of timing advance values is defined based on an offset time value relative to the first timing advance value.

In one configuration, the UE 1600 includes means for receiving a first configuration identifying a plurality of timing advance values, means for receiving a second configuration for a first sounding reference signal (SRS) resource set, and means for transmitting a first SRS on the first SRS resource set using a first timing advance value selected from the plurality of timing advance values based on a usage associated with the first SRS resource set or a time domain configuration associated with the first SRS resource set. In one aspect, the aforementioned means may be the processor 1604 shown in FIG. 16 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1604 is merely provided as an example, and other means for carrying out the described functions may be included within various aspects of the present disclosure, including but not limited to the instructions stored in the computer-readable medium 1606, or any other suitable apparatus or means described in any one or more of FIGS. 1, 2, 3, 7, 8, 9, 15, and 16, and utilizing, for example, the methods and/or algorithms described herein in relation to FIG. 17.

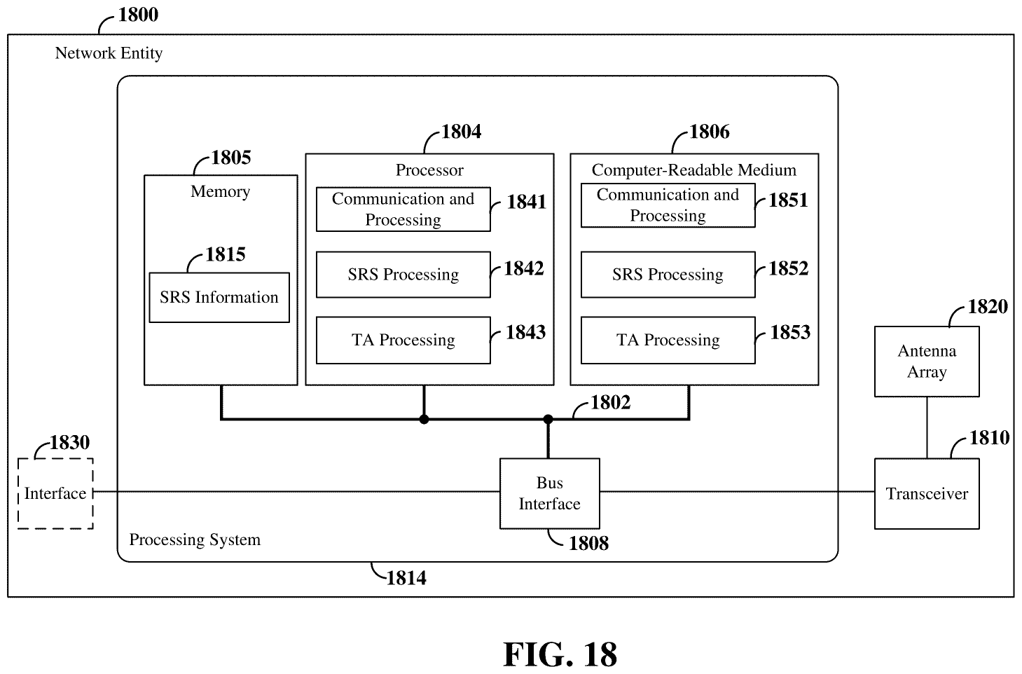

FIG. 18 is a conceptual diagram illustrating an example of a hardware implementation for a network entity 1800 employing a processing system 1814. In some implementations, the network entity 1800 may correspond to any of the base stations, CUs, DUs, RUs, or scheduling entities shown in any of FIGS. 1, 2, 3, 7, 8, 9, and 15.

In accordance with various aspects of the disclosure, an element, or any portion of an element, or any combination of elements may be implemented with the processing system 1814. The processing system may include one or more processors 1804. The processing system 1814 may be substantially the same as the processing system 1614 illustrated in FIG. 16, including a bus interface 1808, a bus 1802, memory 1805, a processor 1804, a computer-readable medium 1806, a transceiver 1810, and an antenna array 1820. The memory 1805 may store SRS information 1815 (e.g., SRS resource information) used by the processor 1804 in cooperation with the transceiver 1810 for communication operations as described herein. Furthermore, the network entity 1800 may include an interface 1830 (e.g., a network interface) that provides a means for communicating with at least one other apparatus within a core network and with at least one radio access network.

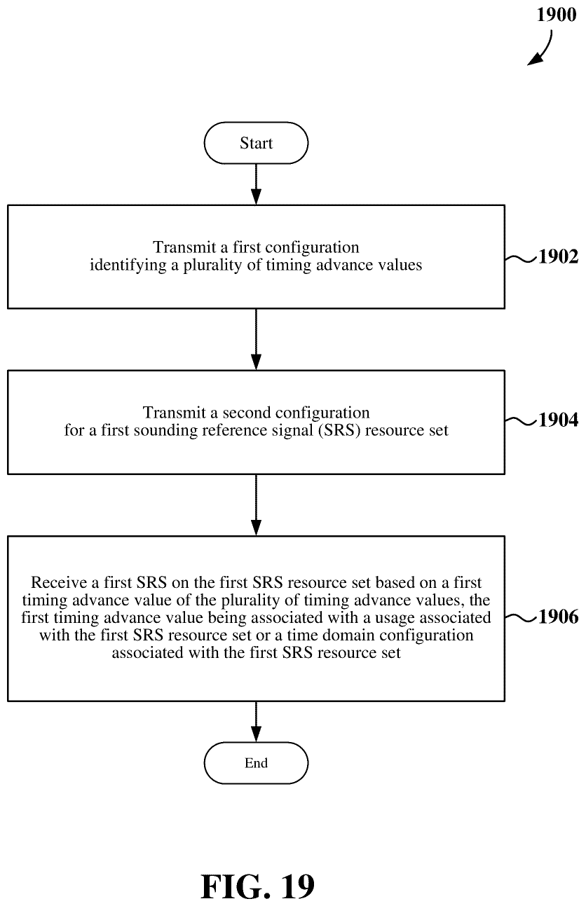

The network entity 1800 may be configured to perform any one or more of the operations described herein (e.g., as described above in conjunction with FIGS. 1-15 and as described below in conjunction with FIG. 19). In some aspects of the disclosure, the processor 1804, as utilized in the network entity 1800, may include circuitry configured for various functions.

The processor 1804 may be configured to generate, schedule, and modify a resource assignment or grant of time-frequency resources (e.g., a set of one or more resource elements). For example, the processor 1804 may schedule time-frequency resources within a plurality of time division duplex (TDD) and/or frequency division duplex (FDD) subframes, slots, and/or mini-slots to carry user data traffic and/or control information to and/or from multiple scheduled entities. The processor 1804 may be configured to schedule resources for the transmission of downlink signals. The processor 1804 may further be configured to schedule resources for the transmission of uplink signals.

In some aspects of the disclosure, the processor 1804 may include communication and processing circuitry 1841. The communication and processing circuitry 1841 may be configured to communicate with a user equipment. The communication and processing circuitry 1841 may include one or more hardware components that provide the physical structure that performs various processes related to communication (e.g., signal reception and/or signal transmission) as described herein. The communication and processing circuitry 1841 may further include one or more hardware components that provide the physical structure that performs various processes related to signal processing (e.g., processing a received signal and/or processing a signal for transmission) as described herein. The communication and processing circuitry 1841 may further be configured to execute communication and processing software 1851 included on the computer-readable medium 1806 to implement one or more functions described herein.

The communication and processing circuitry 1841 may further be configured to receive an indication from the UE. For example, the indication may be included in a MAC-CE carried in a Uu PUSCH or a PSCCH, or included in a Uu RRC message or an SL RRC message, or included in a dedicated Uu PUCCH or PUSCH. The communication and processing circuitry 1841 may further be configured to receive a scheduling request from a UE for an uplink grant or a sidelink grant.

In some implementations wherein the communication involves receiving information, the communication and processing circuitry 1841 may obtain information from a component of the network entity 1800 (e.g., from the transceiver 1810 that receives the information via radio frequency signaling or some other type of signaling suitable for the applicable communication medium), process (e.g., decode) the information, and output the processed information. For example, the communication and processing circuitry 1841 may output the information to another component of the processor 1804, to the memory 1805, or to the bus interface 1808. In some examples, the communication and processing circuitry 1841 may receive one or more of signals, messages, other information, or any combination thereof. In some examples, the communication and processing circuitry 1841 may receive information via one or more channels. In some examples, the communication and processing circuitry 1841 may include functionality for a means for receiving. In some examples, the communication and processing circuitry 1841 may include functionality for a means for decoding. In some examples, the communication and processing circuitry 1841 may include functionality for a means for receiving an SRS on an SRS resource based on a TA value.

In some implementations wherein the communication involves sending (e.g., transmitting) information, the communication and processing circuitry 1841 may obtain information (e.g., from another component of the processor 1804, the memory 1805, or the bus interface 1808), process (e.g., encode) the information, and output the processed information. For example, the communication and processing circuitry 1841 may output the information to the transceiver 1810 (e.g., that transmits the information via radio frequency signaling or some other type of signaling suitable for the applicable communication medium). In some examples, the communication and processing circuitry 1841 may send one or more of signals, messages, other information, or any combination thereof. In some examples, the communication and processing circuitry 1841 may send information via one or more channels. In some examples, the communication and processing circuitry 1841 may include functionality for a means for sending (e.g., a means for transmitting). In some examples, the communication and processing circuitry 1841 may include functionality for a means for encoding.

The processor 1804 may include SRS processing circuitry 1842 configured to perform SRS processing-related operations as discussed herein (e.g., one or more of the operations described above in conjunction with FIGS. 13-15). The SRS processing circuitry 1842 may be configured to execute SRS processing software 1852 included on the computer-readable medium 1806 to implement one or more functions described herein.

The SRS processing circuitry 1842 may include functionality for a means for transmitting a configuration for an SRS resource set (e.g., as described above in conjunction with FIGS. 13-15). For example, the SRS processing circuitry 1842 may transmit an RRC message including the configuration to a UE via a PDSCH.

The processor 1804 may include TA processing circuitry 1843 configured to perform TA processing-related operations as discussed herein (e.g., one or more of the operations described above in conjunction with FIGS. 13-15). The TA processing circuitry 1843 may be configured to execute TA processing software 1853 included on the computer-readable medium 1806 to implement one or more functions described herein.

The TA processing circuitry 1843 may include functionality for a means for transmitting a configuration identifying TA values (e.g., as described above in conjunction with FIGS. 13-15). For example, the TA processing circuitry 1843 may transmit an RRC message including the configuration to a UE via a PDSCH.

In some examples, the network entity 1800 shown and described above in connection with FIG. 18 may be a disaggregated base station. For example, the network entity 1800 shown in FIG. 18 may include the CU and optionally one or more DUs/RUs of the disaggregated base station. Other DUs/RUs associated with the network entity 1800 may be distributed throughout the network. In some examples, the DUs/RUs may correspond to TRPs associated with the network entity. In some examples, the CU and/or DU/RU of the disaggregated base station (e.g., within the network entity 1800) may generate at least one configuration (e.g., including TA values and/or SRS resource sets) and provide the at least one configuration to a user equipment, as well as receive and process an SRS from the user equipment.

FIG. 19 is a flow chart illustrating an example method 1900 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 1900 may be carried out by the network entity 1800 illustrated in FIG. 18. In some examples, the method 1900 may be carried out by any suitable apparatus or means for carrying out the functions or algorithm described below.

At block 1902, a network entity may transmit a first configuration identifying a plurality of timing advance values. In some examples, the TA processing circuitry 1843 together with the communication and processing circuitry 1841 and the transceiver 1810, shown and described in FIG. 18, may provide a means to transmit a first configuration identifying a plurality of timing advance values.

At block 1904, the network entity may transmit a second configuration for a first sounding reference signal (SRS) resource set. In some examples, the SRS processing circuitry 1842 together with the communication and processing circuitry 1841 and the transceiver 1810, shown and described in FIG. 18, may provide a means to transmit a second configuration for a first sounding reference signal (SRS) resource set.

At block 1906, the network entity may receive a first SRS on the first SRS resource set based on a first timing advance value of the plurality of timing advance values, the first timing advance value being associated with a usage associated with the first SRS resource set or a time domain configuration associated with the first SRS resource set. In some examples, the SRS processing circuitry 1842 together with the communication and processing circuitry 1841 and the transceiver 1810, shown and described in FIG. 18, may provide a means to receive a first SRS on the first SRS resource set based on a first timing advance value of the plurality of timing advance values.

In some examples, the network entity may transmit a third configuration including a first control resource set pool value and a second control resource set pool value, the first control resource set pool value being associated with the first timing advance value, and the second control resource set pool value being associated with a second timing advance value of the plurality of timing advance values. In some examples, the first control resource set pool value is associated with a first transmit receive point. In some examples, the second control resource set pool value is associated with a second transmit receive point.

In some examples, the first timing advance value may include a default timing advance value (e.g., associated with beam management SRS usage or antenna switching SRS usage). In some examples, the first timing advance value is associated with a first timing advance group (TAG). In some examples, a second timing advance value of the plurality of timing advance values is associated with a second TAG configured after the first TAG. In some examples, the first timing advance value is associated with a first timing advance group (TAG) associated with a first TAG identifier. In some examples, a second timing advance value of the plurality of timing advance values is associated with a second TAG associated with a second TAG identifier. In some examples, the first TAG identifier has a lower identifier value than the second TAG identifier. In some examples, the first timing advance value is associated with a first timing advance group (TAG). In some examples, a second timing advance value of the plurality of timing advance values is defined based on an offset time value relative to the first timing advance value.

In some examples, the first SRS resource set is associated with codebook SRS usage or noncodebook SRS usage. In some examples, the first SRS resource set is included in an SRS resource set list that is restricted to a single SRS resource set for codebook SRS usage or noncodebook SRS usage. In some examples, the first timing advance value may include a default timing advance value (e.g., associated with the SRS resource set list). In some examples, the first timing advance value is associated with a first timing advance group (TAG). In some examples, a second timing advance value of the plurality of timing advance values is associated with a second TAG configured after the first TAG. In some examples, the first timing advance value is associated with a first timing advance group (TAG) associated with a first TAG identifier. In some examples, a second timing advance value of the plurality of timing advance values is associated with a second TAG associated with a second TAG identifier. In some examples, the first TAG identifier has a lower identifier value than the second TAG identifier. In some examples, the first timing advance value is associated with a first timing advance group (TAG). In some examples, a second timing advance value of the plurality of timing advance values is defined based on an offset time value relative to the first timing advance value.

In some examples, the first SRS resource set is associated with codebook SRS usage or noncodebook SRS usage. In some examples, the network entity may select the first timing advance value based on a first identifier associated with the first SRS resource set. In some examples, the first SRS resource set is included in an SRS resource set list that includes a second SRS resource set. In some examples, the first SRS resource set is associated with the first timing advance value. In some examples, the second SRS resource set is associated with a second identifier and a second timing advance value of the plurality of timing advance values. In some examples, the first identifier has a lower identifier value than the second identifier. In some examples, the first timing advance value is associated with a first timing advance group (TAG). In some examples, the second timing advance value is associated with a second TAG configured after the first TAG. In some examples, the first timing advance value is associated with a first timing advance group (TAG) associated with a first TAG identifier. In some examples, the second timing advance value is associated with a second TAG associated with a second TAG identifier. In some examples, the first TAG identifier has a lower identifier value than the second TAG identifier. In some examples, the first timing advance value is associated with a first timing advance group (TAG). In some examples, a second timing advance value of the plurality of timing advance values is defined based on an offset time value relative to the first timing advance value.

In some examples, the first timing advance value may include a default timing advance value (e.g., associated with periodic SRS resource sets or semi-persistent SRS resource sets). In some examples, the first timing advance value is associated with a first timing advance group (TAG). In some examples, a second timing advance value of the plurality of timing advance values is associated with a second TAG configured after the first TAG. In some examples, the first timing advance value is associated with a first timing advance group (TAG) associated with a first TAG identifier. In some examples, a second timing advance value of the plurality of timing advance values is associated with a second TAG associated with a second TAG identifier. In some examples, the first TAG identifier has a lower identifier value than the second TAG identifier. In some examples, the first timing advance value is associated with a first timing advance group (TAG). In some examples, a second timing advance value of the plurality of timing advance values is defined based on an offset time value relative to the first timing advance value.

In some examples, the network entity may transmit, on a first control resource set, first downlink control information (DCI) that schedules the first SRS resource set as an aperiodic SRS resource set. In some examples, the first control resource set is associated with a first control resource set pool value of a plurality of control resource set pool values. In some examples, the first timing advance value is associated with the first control resource set pool value. In some examples, the first timing advance value is associated with a first timing advance group (TAG). In some examples, a second timing advance value of the plurality of timing advance values is associated with a second TAG configured after the first TAG. In some examples, the first timing advance value is associated with a first timing advance group (TAG) associated with a first TAG identifier. In some examples, a second timing advance value of the plurality of timing advance values is associated with a second TAG associated with a second TAG identifier. In some examples, the first TAG identifier has a lower identifier value than the second TAG identifier. In some examples, the first timing advance value is associated with a first timing advance group (TAG). In some examples, a second timing advance value of the plurality of timing advance values is defined based on an offset time value relative to the first timing advance value.

In one configuration, the network entity 1800 includes means for transmitting a first configuration identifying a plurality of timing advance values, means for transmitting a second configuration for a first sounding reference signal (SRS) resource set, and means for receiving a first SRS on the first SRS resource set based on a first timing advance value of the plurality of timing advance values, the first timing advance value being associated with a usage associated with the first SRS resource set or a time domain configuration associated with the first SRS resource set. In one aspect, the aforementioned means may be the processor 1804 shown in FIG. 18 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable medium 1806, or any other suitable apparatus or means described in any one or more of FIGS. 1, 2, 3, 7, 8, 9, 15, and 18, and utilizing, for example, the methods and/or algorithms described herein in relation to FIG. 19.

The methods shown in FIGS. 17 and 19 may include additional aspects, such as any single aspect or any combination of aspects described below and/or in connection with one or more other processes described elsewhere herein. The following provides an overview of several aspects of the present disclosure.

Aspect 1: A method for wireless communication at a user equipment, the method comprising: receiving a first configuration identifying a plurality of timing advance values; receiving a second configuration for a first sounding reference signal (SRS) resource set; and transmitting a first SRS on the first SRS resource set using a first timing advance value selected from the plurality of timing advance values based on a usage associated with the first SRS resource set or a time domain configuration associated with the first SRS resource set.

Aspect 2: The method of aspect 1, further comprising: receiving a third configuration including a first control resource set pool value and a second control resource set pool value, the first control resource set pool value being associated with the first timing advance value, and the second control resource set pool value being associated with a second timing advance value of the plurality of timing advance values.

Aspect 3: The method of aspect 2, wherein: the first control resource set pool value is associated with a first transmit receive point; and the second control resource set pool value is associated with a second transmit receive point.

Aspect 4: The method of any of aspects 1 through 3, wherein: the first timing advance value comprises a default timing advance value associated with beam management SRS usage or antenna switching SRS usage.

Aspect 5: The method of any of aspects 1 through 3, wherein: the first SRS resource set is associated with codebook SRS usage or noncodebook SRS usage.

Aspect 6: The method of aspect 5, wherein: the first SRS resource set is included in an SRS resource set list that is restricted to a single SRS resource set for codebook SRS usage or noncodebook SRS usage; and the first timing advance value comprises a default timing advance value.

Aspect 7: The method of aspect 5, further comprising: selecting the first timing advance value based on a first identifier associated with the first SRS resource set.

Aspect 8: The method of aspect 7, wherein: the first SRS resource set is included in an SRS resource set list that includes a second SRS resource set; the first SRS resource set is associated with the first timing advance value; the second SRS resource set is associated with a second identifier and a second timing advance value of the plurality of timing advance values; and the first identifier has a lower identifier value than the second identifier.

Aspect 9: The method of any of aspects 1 through 3, wherein: the first timing advance value comprises a default timing advance value associated with periodic SRS resource sets or semi-persistent SRS resource sets.

Aspect 10: The method of any of aspects 1 through 3, wherein: the method further comprises receiving, on a first control resource set, first downlink control information (DCI) that schedules the first SRS resource set as an aperiodic SRS resource set; the first control resource set is associated with a first control resource set pool value of a plurality of control resource set pool values; and the first timing advance value is associated with the first control resource set pool value.

Aspect 11: The method of any of aspects 1 through 10, wherein: the first timing advance value is associated with a first timing advance group (TAG); and a second timing advance value of the plurality of timing advance values is associated with a second TAG configured after the first TAG.

Aspect 12: The method of any of aspects 1 through 10, wherein: the first timing advance value is associated with a first timing advance group (TAG) associated with a first TAG identifier; a second timing advance value of the plurality of timing advance values is associated with a second TAG associated with a second TAG identifier; and the first TAG identifier has a lower identifier value than the second TAG identifier.

Aspect 13: The method of any of aspects 1 through 10, wherein: the first timing advance value is associated with a first timing advance group (TAG); and a second timing advance value of the plurality of timing advance values is defined based on an offset time value relative to the first timing advance value.

Aspect 16: A method for wireless communication at a network entity, the method comprising: transmitting a first configuration identifying a plurality of timing advance values; transmitting a second configuration for a first sounding reference signal (SRS) resource set; and receiving a first SRS on the first SRS resource set based on a first timing advance value of the plurality of timing advance values, the first timing advance value being associated with a usage associated with the first SRS resource set or a time domain configuration associated with the first SRS resource set.

Aspect 17: The method of aspect 16, further comprising: transmitting a third configuration including a first control resource set pool value and a second control resource set pool value, the first control resource set pool value being associated with the first timing advance value, and the second control resource set pool value being associated with a second timing advance value of the plurality of timing advance values.

Aspect 18: The method of aspect 17, wherein: the first control resource set pool value is associated with a first transmit receive point; and the second control resource set pool value is associated with a second transmit receive point.

Aspect 19: The method of any of aspects 16 through 18, wherein: the first timing advance value comprises a default timing advance value associated with beam management SRS usage or antenna switching SRS usage.

Aspect 20: The method of any of aspects 16 through 18, wherein: the first SRS resource set is associated with codebook SRS usage or noncodebook SRS usage.

Aspect 21: The method of aspect 20, wherein: the first SRS resource set is included in an SRS resource set list that is restricted to a single SRS resource set for codebook SRS usage or noncodebook SRS usage; and the first timing advance value comprises a default timing advance value.

Aspect 22: The method of aspect 20, further comprising: selecting the first timing advance value based on a first identifier associated with the first SRS resource set.

Aspect 23: The method of aspect 22, wherein: the first SRS resource set is included in an SRS resource set list that includes a second SRS resource set; the first SRS resource set is associated with the first timing advance value; the second SRS resource set is associated with a second identifier and a second timing advance value of the plurality of timing advance values; and the first identifier has a lower identifier value than the second identifier.

Aspect 24: The method of any of aspects 16 through 18, wherein: the first timing advance value comprises a default timing advance value associated with periodic SRS resource sets or semi-persistent SRS resource sets.

Aspect 25: The method of any of aspects 16 through 18, wherein: the method further comprises transmitting, on a first control resource set, first downlink control information (DCI) that schedules the first SRS resource set as an aperiodic SRS resource set; the first control resource set is associated with a first control resource set pool value of a plurality of control resource set pool values; and the first timing advance value is associated with the first control resource set pool value.

Aspect 26: The method of any of aspects 16 through 25, wherein: the first timing advance value is associated with a first timing advance group (TAG); and a second timing advance value of the plurality of timing advance values is associated with a second TAG configured after the first TAG.

Aspect 27: The method of any of aspects 16 through 25, wherein: the first timing advance value is associated with a first timing advance group (TAG) associated with a first TAG identifier; a second timing advance value of the plurality of timing advance values is associated with a second TAG associated with a second TAG identifier; and the first TAG identifier has a lower identifier value than the second TAG identifier.

Aspect 28: The method of any of aspects 16 through 25, wherein: the first timing advance value is associated with a first timing advance group (TAG); and a second timing advance value of the plurality of timing advance values is defined based on an offset time value relative to the first timing advance value.

Aspect 29: A user equipment comprising: a transceiver configured to communicate with a radio access network, a memory, and a processor coupled to the transceiver and the memory, wherein the processor and the memory are configured to perform any one or more of aspects 1 through 13.

Aspect 30: An apparatus configured for wireless communication comprising at least one means for performing any one or more of aspects 1 through 13.

Aspect 31: A non-transitory computer-readable medium storing computer-executable code, comprising code for causing an apparatus to perform any one or more of aspects 1 through 13.

Aspect 32: A network entity comprising: a transceiver, a memory, and a processor coupled to the transceiver and the memory, wherein the processor and the memory are configured to perform any one or more of aspects 16 through 28.

Aspect 33: An apparatus configured for wireless communication comprising at least one means for performing any one or more of aspects 16 through 28.

Aspect 34: A non-transitory computer-readable medium storing computer-executable code, comprising code for causing an apparatus to perform any one or more of aspects 16 through 28.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-19 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 3, 7, 8, 9, 15, 16, and 18 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment, comprising:
a transceiver;
a memory; and
a processor coupled to the memory and the transceiver, wherein the processor and the memory are configured to:
receive, via the transceiver, a first configuration identifying a plurality of timing advance values,
receive, via the transceiver, a second configuration for a first sounding reference signal (SRS) resource set, and
transmit, via the transceiver, a first SRS on the first SRS resource set using a first timing advance value selected from the plurality of timing advance values based on a usage associated with the first SRS resource set or a time domain configuration associated with the first SRS resource set.

2. The user equipment of claim 1, wherein the processor and the memory are further configured to:
receive a third configuration including a first control resource set pool value and a second control resource set pool value, the first control resource set pool value being associated with the first timing advance value, and the second control resource set pool value being associated with a second timing advance value of the plurality of timing advance values.

3. The user equipment of claim 2, wherein:
the first control resource set pool value is associated with a first transmit receive point; and
the second control resource set pool value is associated with a second transmit receive point.

4. The user equipment of claim 1, wherein:
the first timing advance value comprises a default timing advance value associated with beam management SRS usage or antenna switching SRS usage.

5. The user equipment of claim 1, wherein:
the first SRS resource set is associated with codebook SRS usage or noncodebook SRS usage.

6. The user equipment of claim 5, wherein:
the first SRS resource set is included in an SRS resource set list that is restricted to a single SRS resource set for codebook SRS usage or noncodebook SRS usage; and
the first timing advance value comprises a default timing advance value.

7. The user equipment of claim 5, wherein the processor and the memory are further configured to:
select the first timing advance value based on a first identifier associated with the first SRS resource set.

8. The user equipment of claim 7, wherein:
the first SRS resource set is included in an SRS resource set list that includes a second SRS resource set;
the first SRS resource set is associated with the first timing advance value;
the second SRS resource set is associated with a second identifier and a second timing advance value of the plurality of timing advance values; and
the first identifier has a lower identifier value than the second identifier.

9. The user equipment of claim 1, wherein:
the first timing advance value comprises a default timing advance value associated with periodic SRS resource sets or semi-persistent SRS resource sets.

10. The user equipment of claim 1, wherein:
the processor and the memory are further configured to receive, on a first control resource set, first downlink control information (DCI) that schedules the first SRS resource set as an aperiodic SRS resource set;
the first control resource set is associated with a first control resource set pool value of a plurality of control resource set pool values; and
the first timing advance value is associated with the first control resource set pool value.

11. The user equipment of claim 1, wherein:
the first timing advance value is associated with a first timing advance group (TAG); and
a second timing advance value of the plurality of timing advance values is associated with a second TAG configured after the first TAG.

12. The user equipment of claim 1, wherein:
the first timing advance value is associated with a first timing advance group (TAG) associated with a first TAG identifier;
a second timing advance value of the plurality of timing advance values is associated with a second TAG associated with a second TAG identifier; and
the first TAG identifier has a lower identifier value than the second TAG identifier.

13. The user equipment of claim 1, wherein:
the first timing advance value is associated with a first timing advance group (TAG); and
a second timing advance value of the plurality of timing advance values is defined based on an offset time value relative to the first timing advance value.

14. A method for wireless communication at a user equipment, comprising:
receiving a first configuration identifying a plurality of timing advance values;
receiving a second configuration for a first sounding reference signal (SRS) resource set; and
transmitting a first SRS on the first SRS resource set using a first timing advance value selected from the plurality of timing advance values based on a usage associated with the first SRS resource set or a time domain configuration associated with the first SRS resource set.

15. A user equipment, comprising:
means for receiving a first configuration identifying a plurality of timing advance values;
means for receiving a second configuration for a first sounding reference signal (SRS) resource set; and
means for transmitting a first SRS on the first SRS resource set using a first timing advance value selected from the plurality of timing advance values based on a usage associated with the first SRS resource set or a time domain configuration associated with the first SRS resource set.

16. A network entity, comprising:
a transceiver;
a memory; and
a processor coupled to the memory and the transceiver, wherein the processor and the memory are configured to:
transmit, via the transceiver, a first configuration identifying a plurality of timing advance values,
transmit, via the transceiver, a second configuration for a first sounding reference signal (SRS) resource set, and
receive, via the transceiver, a first SRS on the first SRS resource set based on a first timing advance value of the plurality of timing advance values, the first timing advance value being associated with a usage associated with the first SRS resource set or a time domain configuration associated with the first SRS resource set.

17. The network entity of claim 16, wherein the processor and the memory are further configured to:
transmit a third configuration including a first control resource set pool value and a second control resource set pool value, the first control resource set pool value being associated with the first timing advance value, and the second control resource set pool value being associated with a second timing advance value of the plurality of timing advance values.

18. The network entity of claim 17, wherein:
the first control resource set pool value is associated with a first transmit receive point; and
the second control resource set pool value is associated with a second transmit receive point.

19. The network entity of claim 16, wherein:
the first timing advance value comprises a default timing advance value associated with beam management SRS usage or antenna switching SRS usage.

20. The network entity of claim 16, wherein:
the first SRS resource set is associated with codebook SRS usage or noncodebook SRS usage.

21. The network entity of claim 20, wherein:
the first SRS resource set is included in an SRS resource set list that is restricted to a single SRS resource set for codebook SRS usage or noncodebook SRS usage; and
the first timing advance value comprises a default timing advance value.

22. The network entity of claim 20, wherein:
the processor and the memory are further configured to select the first timing advance value based on a first identifier associated with the first SRS resource set.

23. The network entity of claim 22, wherein:
the first SRS resource set is included in an SRS resource set list that includes a second SRS resource set;
the first SRS resource set is associated with the first timing advance value;
the second SRS resource set is associated with a second identifier and a second timing advance value of the plurality of timing advance values; and
the first identifier has a lower identifier value than the second identifier.

24. The network entity of claim 16, wherein:
the first timing advance value comprises a default timing advance value associated with periodic SRS resource sets or semi-persistent SRS resource sets.

25. The network entity of claim 16, wherein:
the processor and the memory are further configured to transmit, on a first control resource set, first downlink control information (DCI) that schedules the first SRS resource set as an aperiodic SRS resource set;
the first control resource set is associated with a first control resource set pool value of a plurality of control resource set pool values; and
the first timing advance value is associated with the first control resource set pool value.

26. The network entity of claim 16, wherein:
the first timing advance value is associated with a first timing advance group (TAG); and
a second timing advance value of the plurality of timing advance values is associated with a second TAG configured after the first TAG.

27. The network entity of claim 16, wherein:
the first timing advance value is associated with a first timing advance group (TAG) associated with a first TAG identifier;
a second timing advance value of the plurality of timing advance values is associated with a second TAG associated with a second TAG identifier; and
the first TAG identifier has a lower identifier value than the second TAG identifier.

28. The network entity of claim 16, wherein:
the first timing advance value is associated with a first timing advance group (TAG); and
a second timing advance value of the plurality of timing advance values is defined based on an offset time value relative to the first timing advance value.

29. A method for wireless communication at a network entity, comprising:
transmitting a first configuration identifying a plurality of timing advance values;
transmitting a second configuration for a first sounding reference signal (SRS) resource set; and
receiving a first SRS on the first SRS resource set based on a first timing advance value of the plurality of timing advance values, the first timing advance value being associated with a usage associated with the first SRS resource set or a time domain configuration associated with the first SRS resource set.

30. A network entity, comprising:
means for transmitting a first configuration identifying a plurality of timing advance values;
means for transmitting a second configuration for a first sounding reference signal (SRS) resource set; and
means for receiving a first SRS on the first SRS resource set based on a first timing advance value of the plurality of timing advance values, the first timing advance value being associated with a usage associated with the first SRS resource set or a time domain configuration associated with the first SRS resource set.
